(19) United States
(12) Patent Application Publication
(10) Pub. No.: US 2019/0281819 A1
(43) Pub. Date: Sep. 19, 2019

(54) NOVEL PEST REPELLANT FORMULATIONS AND USES THEREOF FOR CROP PROTECTION

(71) Applicants: CULTIVA, LLC, Las Vegas, NV (US); LOCUS AGRICULTURE IP COMPANY, LLC, Solon, OH (US)

(72) Inventors: LUIS HERNANDEZ, LAS VEGAS, NV (US); SEAN MUSSER, LAS VEGAS, NV (US); BRIAN TIPTON, LAS VEGAS, NV (US); PAUL S. ZORNER, ENCINITAS, CA (US)

(21) Appl. No.: 16/352,181

(22) Filed: Mar. 13, 2019

Related U.S. Application Data
(60) Provisional application No. 62/642,358, filed on Mar. 13, 2018.

(51) Int. Cl. A01N 25/04; A01N 37/44

(52) U.S. Cl. CPC A01N 25/04; A01N 37/44

(57) ABSTRACT

The subject invention provides pest repellent compositions and methods of using these repellent compositions for repelling pests, in particular, insect pests that are harmful for crops. Advantageously, the repellent compositions and methods of the subject invention are environmentally-friendly, non-toxic and cost-effective. Specifically, the repellent poses no harm to those insects that are beneficial for agricultural needs.

### CROSS REFERENCE TO A RELATED APPLICATION

This application claims the benefit of U.S. provisional application Ser. No. 62/642,358, filed Mar. 13, 2018, which is incorporated herein by reference in its entirety.

### BACKGROUND OF THE INVENTION

Developing strategies for feeding the world's growing population while reducing pollution and protecting valuable ecosystems is one of the greatest challenges facing producers of food and other consumable products. In the agriculture industry, certain common issues continue to hinder the ability of farmers to maximize production yields while keeping costs low. These include, but are not limited to, infections and infestations caused by bacteria, fungi, and other pests and pathogens; the high costs of chemical fertilizers and herbicides, including their environmental and health impacts; and the difficulty for plants to efficiently absorb nutrients and water from different types of soil.

Insects, in particular, significantly adversely affect agricultural production and human health, creating problems around the globe every day. In addition to destroying agricultural products, insects transmit disease, some of which can cause epidemics.

Widespread infection of citrus plants by pathogens such as the pathogen that causes citrus greening disease has led to significant hardships for citrus growers. Entire crops have been lost to these bacterial infections, leading to a decline in the production, and increase in price, of citrus products worldwide.

Citrus greening disease, also known as Huanglongbing (HLB) or yellow dragon disease, is an incurable infection caused by the Gram-negative bacterium Candidatus Liberibacter asiaticus. This disease has caused devastation for millions of acres of citrus crops throughout the United States and other parts of the world. Infected trees produce fruits that are green, misshapen and bitter, which makes them unsuitable for sale as fresh fruit or for juice. Most infected trees die within a few years, as the disease is incurable. The disease is primarily spread by two species of psyllid insects. One species is the Asian citrus psyllid (ACP), Diaphorina citri, which has been present in Florida since 1998.

Control of pests is usually attempted by the use of pesticides, which function by poisoning via oral ingestion, by contact with the pest cuticle, or by fumigant action through the air. Unfortunately, the use of pesticides not only risks the contamination of the environment or agricultural products, but also is harmful to humans. In addition, the use of insecticides may unintentionally harm beneficial species.

Insect-proof barriers, such as meshes, are sometimes used to keep insects off crops, creating a barrier to help reduce the need for chemicals. Insect-proof barriers, however, are not always suitable to the physical situation in which protection from insects is required.

One alternative to the use of chemical insecticides or insect impermeable barriers is the use of insect repellents. Repellents cause insects to be driven away from, or to reject, a particular area or surface. Repellents have been used for the prevention of breeding, biting and stinging of various insect pests.

Various agents have been developed to be used as insect repellents for agricultural, gardening or other purposes. These agents range from naturally occurring extracts to commercially manufactured compounds. The degree of protection, duration of protection, and safety of these agents varies greatly. Examples of insect repellents include oils, such as mineral and vegetable oils, and synthetic chemicals such as N,N-Diethyl-meta-toluamide (DEET). DEET is the major chemical insect repellent in commercial use. In order for DEET to act as a repellent, it must be used at a concentration of about 5-20 volume percent (vol. %). DEET has been found to pose potential health risks, especially for children. Also, DEET has a limited spectrum of activity and a noticeably unpleasant odor.

Other insect repellents have also been described in U.S. Pat. Nos. 9,523,675; 9,491,942; 9,307,763; and 8,945,595. These Patents are incorporated herein by reference in their entireties.

U.S. Pat. No. 8,752,328 discloses compositions for films that can be used to, for example, reduced moisture-induced cracking of plant parts and/or sun damage with minimal or no negative impact on the environment. The '328 Patent is incorporated herein by reference in its entirety.

Environmental awareness and consumers' demand has promoted the search for better products for pest control and their use in the treatment of agricultural crops, particularly edible crops, namely vegetables and fruits that are marketed from the field to the market.

Thus, there is an increasing need for improved, non-toxic, low-cost, and environmentally-friendly pest repellent materials and technologies that are effective to repel pests, or otherwise prevent or reduce damage to plants by making plants unattractive or offensive to pests, without compromising the environment or the humans and/or animals that produce and consume them.

### BRIEF SUMMARY OF THE INVENTION

The subject invention provides pest repellent compositions and methods of using these compositions for repelling pests, in particular, insect pests that are harmful for crops. Advantageously, the pest repellent compositions and methods of the subject invention are environmentally-friendly, non-toxic and cost-effective. In preferred embodiments, the pest repellent poses no harm to insects or other organisms that are beneficial for agriculture.

Specifically, described herein are films that can be used to repel pests as well as to protect plants, and plant parts. Further, plants that have such films applied to them are also provided.

In preferred embodiments, the films of subject invention include a repellant and a film-forming composition comprising at least three components selected from film forming matrices, hydrophobic barriers, complexing and crosslinking agents, plasticizers, film enhancing agents, UV protectants, and preservatives. Upon application to the plant or plant part, the films form an exogenous layer.

The composition comprises one or more active ingredients, wherein the active ingredient comprises a repellant. In specific embodiments, the repellent is an anthranilate ester. The anthranilate esters that can be used according to the subject invention include, but are not limited to, methyl anthranilate; N,N-dimethyl anthranilic acid; ethyl anthranilate; and butyl anthranilate.

There is provided, in one embodiment, a plant comprising an exogenous film, which film comprises a repellant and a film-forming composition comprising at least three components selected from the group consisting of film forming matrices, hydrophobic barrier agents, complexing and crosslinking agents, plasticizer components, film enhancing agents, UV protectants, and preservatives, wherein the components form the exogenous film when placed on the plant. In some embodiments, the exogenous film covers at least 10% of the plant, or a plant part.

By way of example, in some instances of compositions for use in forming an exogenous film, the exogenous film functions to repel insects and protect the plant, plant part, or other surface on which the film is formed from sun damage, moisture induced cracking, insect infestation, water loss, microbial infection or combinations thereof.

In preferred embodiments, the exogenous film does not substantially alter the taste of the plant. In further preferred embodiments, the exogenous film is edible. In yet further embodiments, the exogenous film increases the shelf life of the plant or a part thereof.

The film-forming composition can comprise, for example, a repellent from about 0.0001% to about 50% by weight, a preservative from about 0.0001% to about 10% by weight; a hydrophobic barrier about 0.001% to about 50% by weight; a filming enhancing agent from about 0.005% to about 24% by weight; a plasticizer from about 0.01% to about 50% by weight; a UV protectant from about 0.001% to about 30% by weight; a film forming matrix from about 0.005% to about 30% by weight; a complexing and crosslinking component from about 0.005% to about 10% by weight; or any three or more thereof independently.

Optionally, the exogenous film in certain instances additionally comprises a nutritional supplement, or more than one nutritional (or other) supplement.

In preferred embodiments, the repellent is methyl, ethyl and/or butyl anthranilate at a concentration of 0.1% to 3% and the film-forming composition is at a concentration of 0.1% to 4%.

Also provided are methods of treating a plant or plant part, which methods comprise contacting the plant or plant part with a composition used in forming an exogenous film as described herein, wherein upon drying the film is formed on the plant or plant part. In examples of such methods, the plant or plant part can be, for example, a fruit, flower or vegetable. In various embodiments of the methods, contacting the plant or plant part comprises spraying the composition onto the plant or plant part; dipping the plant or plant part into the composition; enrobing the plant or plant part with the composition; or a combination thereof. The provided methods can be carried out for instance on a plant part that is a post-harvest fruit, vegetable or flower.

Yet another embodiment provides a method of making a composition for use in forming films on plants and/or plant parts, the method comprising: mixing a repellent and at least three components selected from the group consisting of film forming matrices, hydrophobic barrier agents, complexing and cross linking agents, plasticizer components, film enhancing agents, UV protectants, and preservatives. In one example of this method, upon contacting a balloon with the resultant composition, the balloon volume can be increased by at least 10% without causing cracking of the composition.

Advantageously, the pest repellent composition is useful for protecting a plant or plant part from an insect, for example, settling, biting, laying eggs and/or feeding. In specific embodiments, the pest repellent compositions are also useful for protecting agricultural crops from sun damage, moisture induced cracking, insect infestation, water loss, microbial infection or combinations thereof.

In some embodiments, the pest repellent composition further comprises one or more surfactants such as biosurfactants that are environmentally-friendly, non-toxic and cost-effective. In a specific embodiment, the surfactant is DW80.

The pest repellent compositions can be contacted with any part of the plant, for example, leaves, roots, seeds, stems, flowers, or fruits. Furthermore, the pest repellent compositions can be contacted with an entire plant.

In one embodiment, the subject invention provides methods for repelling pest from an object or an area that comprises treating the object or area with a repelling effective amount of the composition.

In one embodiment, the subjection invention provides a method for repelling an insect, comprising applying to a surface an effect amount of the insect repellent composition to repel said insect. In one embodiment, the surface is a plant, or plant part. In one embodiment, the insect is a psyllid such as ACP.

In one embodiment, this subject invention provides a method of inhibiting, preventing or reducing the incidence of pest-borne disease in a plant, comprising applying to the plant an effect amount of the repellent composition, wherein the settling or attraction of an infected pest to the plant is inhibited, thereby inhibiting, preventing or reducing the incidence of pest-borne disease in the plant. In one embodiment, the pest is a psyllid such as ACP, and the disease is HLB.

In one embodiment, the subject invention provides methods for protecting fruits and vegetables from decay caused by pests after harvesting, which comprises treating the fruit or vegetable with an effective amount of the insect repellent composition. In another embodiment, the subject invention provides methods for extending shelf life of fresh fruits and vegetables that comprises treating the fruits and vegetables with an effective amount of the composition after harvesting.

Advantageously, the present invention can be used without releasing large quantities of inorganic compounds into the environment. Additionally, the subject compositions and methods utilize components that are biodegradable and toxicologically safe.

### BRIEF DESCRIPTION OF THE DRAWINGS

FIG. 1 shows experimental results. The treated and untreated shoots were spaced 6 inches away and a vial of 20 psyllids was placed between them and opened and then the box was sealed.

FIG. 2 shows the repellency against psyllid settlement on citrus shoots in a choice assay. The treatments are F539 2%, F539 1%, F539 0.5%, F539 2% and DW80, F539 1% and DW80, F539 0.5% and DW80, 303d1821 2%, 303d1821 1%, 303d1821 0.5%, 302d22 2%, 302d22 1%, 302d22 0.5%, Parka 0.5%, Danitol and DW80, and untreated check (i.e., control).

FIG. 3A shows the number of living psyllids on treated and untreated shoots.

FIG. 3B shows the percentage of living psyllids on treated and untreated shoots.

FIG. 4 shows psyllid settling preference on treated and untreated shoots.

### DETAILED DESCRIPTION OF THE INVENTION

The subject invention provides pest repellent compositions and methods of using these pest repellent compositions for repelling pests, in particular, insect pests that are harmful for crops. Advantageously, the repellent compositions and methods of the subject invention are environmentally-friendly, non-toxic and cost-effective. In preferred embodiments, the repellent poses no harm to insects and other organisms that are beneficial for agricultural needs.

The subject invention provides films that can be used to repel pests as well as protect plants, and plant parts. Accordingly, plants that have the films on them are also provided. These films include a repellant and at least three components selected from film forming matrices, hydrophobic barrier agents, complexing and crosslinking agents, plasticizers, film enhancing agents, UV protectants, and preservatives. Upon application to the plant or plant part, the films form an exogenous layer.

Advantageously, the film is expandable and flexible, allowing the film to expand as the plant or plant part grows. Such expandability and flexibility of the film contributes to the complete protection of the plant or plant part e.g., fruit or leaf, and prevent cracks from forming in the film that could leave portions of the growing plant or plant part unprotected.

The subject invention also provides compositions for use in forming an exogenous film on plants or plant parts. The composition comprising one or more active ingredients, wherein the active ingredient comprises a repellant and at least three components selected from film forming matrices, hydrophobic barrier agents, complexing and crosslinking agents, plasticizer components, film enhancing agents, UV protectants, and preservatives. Preferably, the repellent is an anthranilate ester. The anthranilate esters include, but not limited to, methyl anthranilate; N,N-dimethyl anthranilic acid; ethyl anthranilate; and butyl anthranilate.

Upon application, the compositions form an exogenous film. Advantageously, the repellent composition is contained within the exogenous film, which provides greater environmental persistence of the composition and thus maintains greater efficacy of the composition for a prolonged period of time. The film can also protect the composition from being washed off by rainfall or irrigation, and protects against UV-induced degradation.

Further, embedding the repellent composition in the film facilitates the use of volatile compounds in the composition because the volatilization of these compounds is inhibited. It is further possible to regulate the release into the environment and exposure to target pests of these compounds from within the film thus facilitating greater utility to food producers by allowing adjustment of film/compound ratios as a function of crop, environment and behavior of the targeted pest.

The pest repellent composition comprises a repellent and at least three components selected from film forming matrices, hydrophobic barrier agents, complexing and crosslinking agents, plasticizers, film enhancing agents, UV protectants, and preservatives. In one embodiment, the repellent component is an anthranilate ester selected from methyl anthranilate; N,N-dimethyl anthranilic acid; ethyl anthranilate; and butyl anthranilate. Preferably, the anthranilate ester is butyl anthranilate.

In one embodiment, the pest repellent composition may comprise volatile compounds such as leaf volatiles including, but not limited to, monoterpenes (e.g., linalool, d-limonene, myrcene, α- and β-phellandrene), sesquiterpenes (e.g., t-caryophellene, γ-elemene, β-elemene, germacrene D, and geranyl acetate), and aliphatic aldehydes (e.g., undecanal, neral, geranial, and citronellal).

The repellent composition is also useful for protecting a plant or plant part from, for example, pest settling, biting, laying eggs and/or feeding. In specific embodiments, the repellent compositions are useful for protecting agricultural crops from sun damage, moisture induced cracking, pest infestation, water loss, microbial infection or combinations thereof.

In some embodiments, the pest repellent comprises about 0.05% to about 10% by weight of the composition, the hydrophobic barrier component in an amount ranging from about 1% to about 25% by weight, the complexing and crosslinking component in an amount ranging from about 0.05% to about 10% by weight, the plasticizer component in an amount ranging from about 0.5% to about 35% by weight, the film enhancing component in an amount ranging from about 0.01% to about 15% by weight.

In one embodiment, the pest repellent composition is an aqueous composition comprising about 64% to about 82% water by weight.

In certain embodiments, the pest repellent compositions are contacted with any part of the plant including, for example, leaves, roots, seeds, stems, flowers, or fruits.

The subject invention provides methods for repelling pests from an object or surface that comprises treating the object or surface with a repelling-effective amount of the composition.

In one embodiment, the subjection invention provides a method for repelling a pest, comprising applying to a surface an effect amount of the repellent composition to repel the pest. In one embodiment, the surface is a plant, or plant part. Preferably, the plant is a citrus plant.

In certain embodiments, the pests can be, for example, psyllids such as ACP; moths such as European Grapevine Moth (lobesia botrana or EGVM), False Codling Moth (Thaumatotibia leucotreta or FCM), European Gypsy Moth (Lymantria dispar or EGM), Indian Meal Moth (Plodiainterpunctella), Angoumois Grain Moth (Sitotroga cerealella), Rice moth (Corcyra cephalonica), and Light Brown Apple Moth (Epiphyas postvittana or LBAM); beetles such as Asian Longhorned Beetle (Anoplophora glabripennis, or ALB), Coconut Rhinoceros Beetle (Oryctes rhinoceros), Emerald Ash Borer beetle (Agrilus planipennis or EAB), Rust Red Flour Beetle (Tribolium spp.), Sawtooth Grain Beetle (Oryzaephilussurinamensis), Flat Grain Beetle (Cryptolestes spp.), and Khapra Beetle (Trogoderma granarium); flies such as Mediterranean Fruit Fly (Ceratitis capitata or Medfly), Mexican Fruit Fly (Anastrepha ludens), and Oriental Fruit Fly (Bactrocera dorsalis); and ants such as Imported fire ants (Solenopsis invicta Buren, S. richteri Forel).

In certain embodiments, the psyllid can be, for example, an Asian Citrus Psyllid (Diaphorina citri), an African Citrus Psyllid (Trioza erytreae), a Pear Psyllid (Cacopsylla (Psylla) pyri), a Carrot Psyllid (Trioza apicalis), a Potato Psyllid (Bactericera (Paratrioza) cockerelli), and a psyllid of the family Psyllidae (Hemiptera). In a specific embodiment, the psyllid is an Asian Citrus Psyllid Diaphorina citri.

In certain embodiment, the pests can be mosquitoes such as the genus Anopheles, Trypanosoma, Aedes spp. (e.g., Aedes aegypti), Culex, Mansonia, and Anopheles; flies such as sand flies, horse flies, tsetse flies and deer flies; and eye gnats such as Hippelates.

In one embodiment, the subject invention provides a psyllid repellent composition comprising one or more active ingredients, wherein the active ingredient comprises at least one repellant. The composition further comprises at least three components selected from film forming matrices, hydrophobic barrier agents, complexing and crosslinking agents, plasticizers, film enhancing agents, UV protectants, and preservatives. Preferably, the repellant is an anthranilate ester selected from the group consisting of methyl anthranilate; N,N-dimethyl anthranilic acid; ethyl anthranilate; and butyl anthranilate. In a specific embodiment, the psyllid is an ACP.

The subject invention also provides methods for protecting agricultural crops against pests that comprises treating the crops to be protected with an effective amount of the repellent composition prior to harvesting.

In one embodiment, the subject invention provides methods for protecting fruits and vegetables from decay caused by attack by pests after harvesting, which comprises treating the fruit or vegetable with an effective amount of the repellent composition. In another embodiment, the subject invention provides methods for extending shelf life of fresh fruits and vegetables that comprises treating the fruits and vegetables with an effective amount of the composition before or after harvesting.

### Selected Definitions

As used herein, the term “insect” refers to any member of a large group of invertebrate animals characterized, in the adult state by division of the body into head, thorax, and abdomen, three pairs of legs, and, often (but not always) two pairs of membranous wings. This definition therefore includes, but not limited to a variety of biting insects (e.g., ants, bees, black flies, chiggers, fleas, green head flies, mosquitoes, stable flies, ticks, and wasps), Wood-boring insects (e.g., termites), noxious insects (e.g., house flies, cockroaches, lice, roaches, and wood lice), and household pests (e.g., flour and bean beetles, dust mites, moths, silverfish, bed bugs, carpet beetles, furniture beetles, book lice, clothes moths, spiders and weevils). Other examples include locusts, caterpillars, bugs, hoppers, and aphids. This definition also includes non-adult insect states include larva and pupa.

As used herein, the term “pest repellent” or “pest repellent composition” or “repellent composition” refers to a compound or composition that deters pests from a surface, e.g., plants. Typically, pest repellents are a compound or composition that can be either topically applied to a host, materials or surfaces; or, the compound or composition is incorporated into the host, materials or surface to produce a repellent article that deters pests from the nearby 2- or 3-dimensional space in which the host, materials or surface exists. The affect of the repellent is typically to drive the pests away from or to reject the host, materials or surface, e.g., plants, thereby minimizing the frequency of pest “bites” or settlement to the host, materials or surface, and protecting the, for example, plants from damage.

As used herein, “agriculture” means the cultivation and breeding of plants for food, fiber, biofuel, medicines, cosmetics, supplements, ornamental purposes and other uses. According to the subject invention, agriculture can also include horticulture, landscaping, gardening, plant conservation, orcharding and arboriculture.

As used here, the term “plant” includes, but is not limited to, any species of woody, ornamental or decorative, crop or cereal, fruit or vegetable, fruit plant or vegetable plant, flower or tree. It also refers to a unicellular plant (e.g. microalga) and a plurality of plant cells that are largely differentiated into a colony (e.g. volvox) or a structure that is present at any stage of a plant's development. Such structures include, but are not limited to, a fruit, a seed, a shoot, a stem, a leaf, a flower petal, etc.

Furthermore, the plant can be standing alone, for example, in a garden, or it can be one of many plants, for example, as part of an orchard or farm crop. Example of plants for which the subject invention is useful include, but are not limited to, cereals and grasses (e.g., wheat, barley, rye, oats, rice, maize, sorghum, corn), beets (e.g., sugar or fodder beets); fruit (e.g., grapes, strawberries, raspberries, blackberries, pomaceous fruit, stone fruit, soft fruit, apples, pears, plums, peaches, almonds, cherries or berries); leguminous crops (e.g., beans, lentils, peas or soya); oil crops (e.g., oilseed rape, mustard, poppies, olives, sunflowers, coconut, castor, cocoa or ground nuts); cucurbits (e.g., pumpkins, cucumbers, squash or melons); fiber plants (e.g., cotton, flax, hemp or jute); citrus fruit (e.g., oranges, lemons, grapefruit or tangerines); vegetables (e.g., spinach, lettuce, asparagus, cabbages, carrots, onions, tomatoes, potatoes or bell peppers); Lauraceae (e.g., avocado, Cinnamonium or camphor); and also tobacco, nuts, herbs, spices, medicinal plants, coffee, eggplants, sugarcane, tea, pepper, grapevines, hops, the plantain family, latex plants, cut flowers and ornamentals.

The term “plant tissue” includes differentiated and undifferentiated tissues of plants including those present in roots, shoots, leaves, pollen, seeds and tumors, as well as cells in culture (e.g., single cells, protoplasts, embryos, callus, etc.). Plant tissue may be in planta, in organ culture, tissue culture, or cell culture. The term “plant part” as used herein refers to a plant structure or a plant tissue.

Ranges provided herein are understood to be shorthand for all of the values within the range. For example, a range of 1 to 20 is understood to include any number, combination of numbers, or sub-range from the group consisting of 1, 2, 3, 4, 5, 6, 7, 8, 9, 10, 11, 12, 13, 14, 15, 16, 17, 18, 19, 20, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

As used herein, the singular forms “a,” “an” and “the” are intended to include the plural forms as well, unless the context clearly indicates otherwise. Further, to the extent that the terms “including,” “includes,” “having,” “has,” “with,” or variants thereof are used in either the detailed description and/or the claims, such terms are intended to be inclusive in a manner similar to the term “comprising.”

The phrases “consisting essentially of” or “consists essentially of” indicate that the claim encompasses embodiments containing the specified materials or steps and those that do not materially affect the basic and novel characteristic(s) of the claim. Use of the term “comprising” contemplates other embodiments that “consist” or “consist essentially of” the recited component(s).

The term “about” means within an acceptable error range for the particular value as determined by one of ordinary skill in the art, which will depend in part on how the value is measured or determined, i.e., the limitations of the measurement system. Where particular values are described in the application and claims, unless otherwise stated the term “about” meaning within an acceptable error range for the particular value should be assumed. In the context of compositions containing amounts of ingredients where the terms “about” or “approximately” are used, these compositions contain the stated amount of the ingredient with a variation (error range) of 0-10% around the value (X±10%).

### Pest Repellent Compositions

The compositions described herein can be prepared using any method known in the art that produces a composition, such as a dispersion or an emulsion, that, upon application to a surface, forms a film. The term “film” as used herein includes the creation of a layer on the exterior side of a plant or plant part. The layer does not need to be of uniform thickness or completely homogeneous in composition. Moreover, the film does not need to completely cover the object or surface to which it is applied. In some examples the film covers only 10%, 20%, 30%, 40%, 50%, 60%, 70%, 80% or 90% of the surface area of a plant or plant part. In other examples, the thickness of the film varies by 10%, 20%, 30%, 40%, 50%, 60%, 70%, 80% or 90% over the object that is contacted with the film.

In some examples the film is not completely homogeneous throughout the surface that is coated. For example, when the composition that is used to coat a plant or plant part is an emulsion, the emulsion may display some degree of phase separation. In such instances, the components in the film may vary in concentration over the surface area of the plant or plant part. The film, however, will maintain the activity that is desired. For example, the film will decrease moisture induced cracking, insect infestation, nematode infestation, microbial infection, sun damage, or combinations thereof.

In certain embodiments, components of the compositions described herein are edible and in some examples they have a regulatory status of generally recognized as safe (GRAS) as provided by the United States Food and Drug Administration. In other embodiments, the components are listed on the Environment Protection Agency's 4A and 4B lists as being safe for the environment.

The pest repellent compositions of the subject invention have a number of beneficial properties that are useful for repelling a pest, such as a psyllid, and for protecting agricultural crops against pests, and/or pest-spread diseases. The pest repellent compositions also are beneficial for protecting fruits and vegetables from decay caused by attack by pests after harvesting. As a result, the pest repellent compositions are useful for extending shelf life of fresh fruits and vegetables after harvesting.

The components used to make the compositions described herein include repellents, preservatives, complexing and cross linking agents, filming agents, plasticizers, hydrophobic barriers, UV protectants, and film forming matrices.

### Pest Repellent Component

In one embodiment, the pest repellent component that can be included in the composition is any molecule that can repel a pest or drive a pest away from a surface. In specific embodiments, the repellent comprises an anthranilate ester selected from methyl anthranilate; N,N-dimethyl anthranilic acid; ethyl anthranilate; and butyl anthranilate. More specifically, the anthranilate ester can be butyl anthranilate.

In one embodiment, the repellent component may comprise one or more active ingredients selected from the group consisting of butanal; pentanal; hexanal; pentanol; hexanol; cyclohexanol; Z-3-hexen-1-ol; Z-2-hexen-1-ol; 1-hexen-3-ol; 1-hepten-3-ol; 3-hexanol; 2-hexanol; butanedione (2,3-butanedione); pentanedione; and 2,3-dimethyl-5-isobutyl pyrizine.

In another embodiment, the repellent component may further comprise one or more compounds selected from citrus volatiles, guava volatiles, synthetic compounds, and any combination thereof. In one embodiment, the citrus volatile is selected from the group consisting of Sabinene, α-Humulene, β-Caryophyllene, (E)-Ocimene, Myrcene, Terpinolene, α-Terpinol, β-Cymene, δ-3-Carene, Octanal, E-2-Hexenal, Limonene (+), γ-Terpinene, Citral, Citronellal, Limonene (−), Acetic Acid, Pentyl Acetate, Acetophenone, Isobutyl Acetate, 3-Methyl-1-Butanol, 1-Hexanol, Ethyl Butyrate, Dipropyldisulfide, (Z)-2-Hexanol, Propionic acid, (+)-Carvone, Methyl Butyrate, α-Terpinene, Nonanal, and (Z)-3-Hexen-1-ol. In another embodiment, the guava volatile is selected from (Z)-3-Hexenal, benzaldehyde, and (E,E)-2,4-hexadienal. In yet another embodiment, the synthetic compound is selected from methyl salicylate and isobutyricacid.

Exemplary other repellent compounds that may be used with the insect repellent composition according to the subject invention, include, but are not limited to: benzil; benzyl benZoate; 2,3,4,5-bis(butyl-2-ene)tetrahydrofurfural (MGK Repellent 11); butoxypolypropylene glycol; N-butylacetanilide; nor-mal-butyl-6,6-dimethyl-5,6-dihydro-1,4-pyrone-2-carboxy late (Indalone); dibutyl adipate; dibutyl phthalate; di-nor-mal-butyl succinate (Tabatrex); N,N-diethyl-metatoluamide (DEET); dimethyl carbate (endo,endo)-dimethyl bicyclo[2.2.1]hept-5-ene-2,3-dicarboxylate); dimethyl phthalate; 2-ethyl-2-butyl-1,3-propanediol; 2-ethyl-1,3-hexanediol (Rutgers 612); di-normal-propyl isocinchomeronate (MGK Repellent 326); 2-phenylcyclohexanol; normal-propyl N,N-diethylsuccinamate, 1-piperidinecarboxylic acid 2-(2-hydroxymethyl) 1-methylpropylester (Bayrepel) and p-menthane-3,8-diol.

The repellent component can be used at any concentration that allows the composition to repel a pest. Exemplary concentrations of the insect repellent component that can be used in the compositions include from about 0.0001% to about 80%, from about 0.001% to about 70%, from about 0.005% to about 60%, from about 0.01% to about 50%, from about 0.05% to about 40%, from about 0.1% to about 30%, from about 0.2% to about 20%, from about 0.3% to about 15%, from about 0.4% to about 10%, from about 0.5% to about 5%, about 0.1% to about 3%, about 0.5% to about 2.5%, and any percentages therebetween. Other exemplary concentrations of the anthranilate esters may be from about 0.001% to about 40%, from about 0.01% to about 40%, from about 0.1% to about 40%, from about 1% to about 40%, from about 2% to about 40%, from about 5% to about 40%, and any percentages therebetween.

Other exemplary concentrations of the anthranilate esters can be used include, but not limited to, 0.001%, 0.01%, 0.02%, 0.05%, 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 355, 36%, 37%, 38%, 39%, 40%, 41%, 42%, 43%, 44%, 45%, 46%, 47%, 48%, 49%, and 50% (w/v). These concentrations can also be the endpoints of ranges.

Advantageously, the repellent component according to the subject invention is non-toxic and can be applied in high concentrations without causing irritation to areas that are in contact with such compositions. Thus, the subject invention is also useful where application of the repellent compositions occurs in the presence of living organisms, such as farmers and growers.

In one embodiment, the repellent component may be dissolved in one or more suitable solvents including, but not limited to, water, Glycerol, N-Methylpyrrolidone, Benzyl alcohol, PCL Liquid 100, Ethanol, Solvesso 200 Solvent, Van-Sol 63, Isopar M, Diethylene glycol methyl ether, Jeffsol AG-1705, Jeffsol AG 1560, Propylene Carbonate, Pelemol DIA, Omnia Solvent, Isopropyl alcohol, Isopropyl myristate, Jeffsol AG-1555, Jeffsol AG-1732, Octyl acetate, Transcutol CG, Citroflex 2, Citroflex A4, Finsolv TN, TIIFA, Poly-solv TPM, Poly-solv DPM, and AgsolEx BLO.

In specific embodiments, anthranilate esters are dissolved in N-methylpyrrolidone, Benzyl alcohol, or Van-Sol 63. Exemplary concentrations of these compounds that can be used in the compositions include from about 0.001% to about 99%, from about 0.005% to about 90%, from about 0.001% to about 80%, from about 0.005% to about 70%, from about 0.01% to about 60%, from about 0.05% to about 50%, from about 0.1% to about 40%, from about 0.5% to about 30%, from about 1% to about 20%, from about 2% to about 10%, and any percentages therebetween.

### Film-Forming Composition

Exemplary concentrations of the film-forming composition include from about 0.0001% to about 80%, from about 0.001% to about 70%, from about 0.005% to about 60%, from about 0.01% to about 50%, from about 0.05% to about 40%, from about 0.1% to about 30%, from about 0.2% to about 20%, from about 0.3% to about 15%, from about 0.4% to about 10%, from about 0.5% to about 5%, about 0.1% to about 3%, about 0.5% to about 2.5%, and any percentages therebetween.

Other exemplary concentrations of the film-forming composition include, but not limited to, 0.001%, 0.01%, 0.02%, 0.05%, 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 355, 36%, 37%, 38%, 39%, 40%, 41%, 42%, 43%, 44%, 45%, 46%, 47%, 48%, 49%, and 50% (w/v). These concentrations can also be the endpoints of ranges. In preferred embodiments, the film-forming composition is about 0.5% to about 5%.

### Preservative Component

In one embodiment, the preservative included in the composition is any molecule that can be used to increase the field or shelf life of a plant or plant part, including for example fruits, flowers, and vegetables. Preservative components can include fungicides and bactericides. Generally shelf life refers to the amount of time that a particular plant or plant part can be maintained in saleable condition after it has been harvested. Similarly, the field life refers to the amount of time that a plant, or plant part can be maintained in a field and still allow for the plant part to be harvested in saleable condition.

Exemplary ingredients that can be used as preservative include parabens including methyl parabens and propyl parabens, sodium benzoate (and other benzoate salts), calcium acetate, sodium acetate, isopropyl alcohol, vanillin, ethylvanillin, ascorbyl palmitate, propanoic acid (and its sodium or potassium, and calcium salts), sodium sorbate (and other salts of sorbic acid), tocopherols, (x-tocopherol), vitamin E acetate, ethanol, butanol, phenol, propyl gallate, benzyl alcohol, butylated hydroxyl anisole (BHA), butylated hydroxyl toluene (BHT), imidazolidinyl urea, diazolidinyl urea, ethylenediaminetetraacetic (EDTA) and all its salts, silicates such as calcium silicate, aluminum magnesium silicate, aluminum calcium silicate, magnesium silicate, aluminum sodium silicate, aluminum potassium silicate, aluminum sodium potassium silicate, other water soluble silicates and combinations of two or more thereof. Exemplary concentrations of preservative in the compositions include from about 0.0001% to about 15%, from about 0.01% to about 10%, from about 0.02% to about 9%, from about 0.05% to about 8%, from about 0.07% to about 7%, from about 0.10% to about 6%, from about 0.15% to about 5%, and any percentages therebetween. In one embodiment the preservative is a biosurfactant.

Table 1 contains preservative components and exemplary concentrations. The preservative component if included in the composition may increase the shelf-life of the composition during storage, shipping, exhibiting for sale and handling that may happen prior to use of the product by the end user for the uses outlined herein for the compositions detailed in the current document.

The exemplary concentration ranges for the various components in Tables 1-7 are the concentrations that are formed when the concentrated compositions containing these components are diluted appropriately for use on a surface such as a plant or plant part. The concentrated compositions may have much higher concentrations of the component substances wherein the compositions could have the consistency of fluid liquid to a very thick paste, but upon appropriate dilution for use produce the concentrations presented in Tables 1-7 for use on a surface.

TABLE 1
Preservative component

| | Exemplary | Exemplary |
|---|---|---|
| | Concentration | Concentration |
| Preservative component | Range 1* | Range 2* |
| Sodium Acetate, Acetic | 0.005% to 0.02% | 0.0025% to 0.10% |
| acid | | |
| Calcium Acetate | 0.005% to 0.02% | 0.0025% to 0.10% |
| Sodium Benzoate, | 0.005% to 0.02% | 0.0025% to 0.1% |
| Benzoic Acid | | |
| Isopropyl Alcohol | 0.01% to 0.5% | 0.0025% to 1.0% |
| Potassium or Sodium | 0.005% to 0.02% | 0.0025% to 0.2% |
| Sorbate, and Sorbic acid | 0.005% to 0.02% | 0.0025% to 0.1% |
| Vanillin | 0.001% to 0.02% | 0.00025% to 0.05% |
| Ethylvanillin | 0.002% to 0.02% | 0.00025% to 0.05% |
| Propanoic acid and its | 0.005% to 0.02% | 0.00025 to 0.10% |
| sodium or potassium, | | |
| and calcium salts | | |
| Ascorbyl Palmitate | 0.001% to 0.02% | 0.00025 to 0.10% |
| Methyl-p-hydroxy- | 0.00015% to 0.005% | 0.00005% to 0.015% |
| benzoate, i.e., | | |
| Methyl Parabens and | | |
| its sodium salt | | |
| Propyl-p-hydroxy- | 0.0001% to 0.001% | 0.000025% to 0.012% |
| benzoate, i.e., | | |
| Propyl Parabens and | | |
| its sodium salt | | |
| Butanol | 0.005% to 0.05% | 0.001% to 0.20% |
| Ethanol | 0.01% to 0.1% | 0.0025% to 0.70% |
| Phenol | 0.0005% to 0.05% | 0.0025% to 0.1% |
| Propyl gallate | 0.0002% to 0.02% | 0.00005% to 0.01% |
| Benzyl Alcohol | 0.005% to 0.05% | 0.0002% to 0.1% |
| Phenoxy ethanol | 0.0001% to 0.01% | 0.00005% to 0.25% |
| Ethyl-p-hydroxybenzoate | 0.0001% to 0.01% | 0.000025% to 0.02% |
| Butyl-p-hydroxybenzoate | 0.0001% to 0.01% | 0.000025% to 0.02% |
| Phenoxy Ethanol | 0.0015% to 0.015% | 0.0005% to 0.10% |
| Ethyl propionate | 0.0001% to 0.01% | 0.000025% to 0.2% |
| Ethyl Butyrate | 0.0001% to 0.01% | 0.000025% to 0.2% |
| p-chloro-m-xylenol | 0.0001% to 0.01% | 0.000025% to 0.1% |
| Vitamin E (α-tocopherol) | 0.0001% to 0.01% | 0.00005% to 0.1% |
| Butylated hydroxy- | 0.0005% to 0.005% | 0.0001% to 0.01% |
| anisole (BHA) | | |
| Butylated hydroxy- | 0.0001% to 0.005% | 0.00001% to 0.05% |
| toluene (BHT) | | |
| Imidazolidinyl urea | 0.0001% to 0.01% | 0.00005% to 0.05% |
| Diazolidinyl urea | 0.0001% to 0.01% | 0.00005% to 0.10% |
| Sodium and potassium | 0.00005% to 0.005% | 0.00001% to 0.05% |
| salts of ethylenediamine- | | |
| tetraacetate | | |

*All concentrations are approximate and can be 10% greater or less than the value provided.

### Film Enhancing Component

The film enhancing component, according to the subject invention, is any molecule (or mixture of molecules) that can be used to enhance film spreading. Exemplary ingredients that can be used as film enhancing components include potassium silicate, calcium silicate, aluminum magnesium silicate, aluminum calcium silicate, magnesium silicate, aluminum sodium silicate, aluminum potassium silicate, aluminum sodium potassium silicate, magnesium trisilicate, silica, silicic acid and it salts, siloxanes, dimethicone copolyol, dimethicone copolyol fatty acid esters or ethers, silicone glycol copolymer, other water soluble silicates, isopropyl myristate, isopropyl palmitate, butyl stearate, diisopropyladipate, diacetyl adipate, dibutyl adipate, dioctyl adipate, glyceryl adipate, myristylmyristate, oleic acid, soybean oil, vegetable oil, ethyl oleate and combinations of two or more.

The film enhancing component can be used at any concentration that allows the composition to spread and form a film. One of ordinary skill in the art will be able to determine the appropriate concentration of film enhancing component needed for a specific purpose. Exemplary concentrations of film enhancing components that can be used in the compositions include from about 0.005% to about 15%, from about 0.02% to about 9%, from about 0.05% to about 8%, from about 0.07% to about 7%, from about 0.10% to about 6%, and from about 0.15% to about 5%. Table 2 provided below contains additional film enhancing components and exemplary concentrations.

TABLE 2
Film enhancing component

| | Exemplary | Exemplary |
|---|---|---|
| | Concentration | Concentration |
| Film Enhancing component | Range 1* | Range 2* |
| Potassium silicate | 0.005% to 0.1% | 0.001% to 0.5% |
| Calcium silicate | 0.005% to 0.1% | 0.001% to 0.5% |
| Aluminum magnesium silicate | 0.005% to 0.1% | 0.001% to 0.5% |
| Aluminum calcium silicate | 0.005% to 0.1% | 0.001% to 0.5% |
| Magnesium silicate | 0.005% to 0.1% | 0.001% to 0.5% |
| Aluminum sodium silicate | 0.005% to 0.1% | 0.001% to 0.5% |
| Aluminum potassium silicate | 0.005% to 0.1% | 0.001% to 0.5% |
| Aluminum sodium potassium | 0.005% to 0.1% | 0.001% to 0.5% |
| silicate | | |
| Magnesium trisilicate | 0.005% to 0.1% | 0.001% to 0.5% |
| Dimethicone copolyol | 0.005% to 0.1% | 0.001% to 0.75% |
| Dimethicone copolyol fatty | 0.005% to 0.1% | 0.001% to 0.75% |
| acid esters or ethers | | |
| Silicone glycol copolymer | 0.005% to 0.1% | 0.001% to 0.75% |
| Isopropyl myristate | 0.005% to 0.1% | 0.001% to 0.75% |
| Isopropyl palmitate | 0.005% to 0.1% | 0.001% to 0.75% |
| Isopropyl stearate | 0.005% to 0.1% | 0.001% to 0.75% |
| Butyl stearate | 0.005% to 0.1% | 0.001% to 0.75% |
| Diisopropyladipate | 0.005% to 0.1% | 0.001% to 0.75% |
| Diacetyl adipate | 0.005% to 0.1% | 0.001% to 0.75% |
| Dibutyl adipate | 0.005% to 0.1% | 0.001% to 0.75% |
| Dioctyl adipate | 0.005% to 0.1% | 0.001% to 0.75% |
| Glyceryl adipate | 0.005% to 0.1% | 0.001% to 0.75% |
| Myristylmyristate | 0.005% to 0.1% | 0.001% to 0.75% |
| Myristyl alcohol | 0.005% to 0.1% | 0.001% to 0.75% |
| Oleic acid | 0.005% to 0.1% | 0.001% to 0.75% |
| Soybean oil | 0.005% to 0.1% | 0.001% to 0.75% |
| Vegetable oils, or plant oils | 0.005% to 0.1% | 0.001% to 0.75% |
| Ethyl oleate | 0.005% to 0.1% | 0.001% to 0.75% |

*All concentrations are approximate and can be 10% greater or less than the value provided.

### Plasticizing Component

The plasticizing component is any molecule (or mixture of molecules) that can be used to allow the composition to form a firm phase but also allows flexibility of the film formed such that it can expand as the plant or plant part e.g., fruit or leave grows. Advantageously, such expandability improves the protection of the plant or plant part e.g., fruit or leaf and prevents cracks from happening in the film. Such cracks could leave portions of the growing plant or plant part unprotected.

Exemplary ingredients that can be used as plasticizer include glycerin, propylene glycol, sorbitol solutions, sorbitan monostearate, sorbitan monooleate, lactamide, acetamide DEA, lactic acid, polysorbate 20, 60 and 80, polyoxyethylene-fatty esters and ethers, sorbitan fatty acid esters, polyglyceryl-fatty acid esters, triacetin, dibutyl sebacate and combinations of two or more.

The plasticizing component can be used at any concentration that allows the composition to form a firm phase. A Brookfield viscometer can be used to test the viscosity of the biofilm and exemplary ranges of viscosity include from about 10,000 to about 35,000 centipoise, or from about 5,000 to about 40,000 centipoise on initial formulation and from about 6,000 to about 25,000, or from about 7,000 to about 30,000 after standing. In some examples, formulations that form emulsions display a particle size distribution of the micelles ranging from about 300.0 nanometers to about 350.0 microns. One of ordinary skill in the art will be able to determine the concentration of the plasticizing component needed for a particular application. Exemplary concentrations of plasticizing agents that can be used in the compositions include from about 0.01% to about 40%, from about 8% to about 35%, 20 from about 10% to about 30%, and from about 15% to about 25%. Table 3 provided below contains additional plasticizing components and exemplary concentrations.

TABLE 3
Plasticizing component

| | Exemplary | Exemplary |
|---|---|---|
| | Concentration | Concentration |
| Plasticizing Component | Range 1* | Range 2* |
| Glycerin | 0.05% to 0.5% | 0.001% to 0.75% |
| Propylene glycol | 0.05% to 0.5% | 0.001% to 0.75% |
| Sorbitol solutions | 0.01% to 0.5% | 0.001% to 0.75% |
| Sorbitan monostearate | 0.01% to 0.5% | 0.001% to 0.75% |
| Sorbitan monoleate | 0.01% to 0.5% | 0.001% to 0.75% |
| Lactamide | 0.001% to 0.5% | 0.001% to 0.75% |
| Acetamide DEA | 0.01% to 0.5% | 0.001% to 0.75% |
| Lactic acid | 0.001% to 0.5% | 0.001% to 0.6% |
| Polysorbate 20, 60, 80 | 0.01% to 0.5% | 0.001% to 0.75% |
| Polyoxyethylene-fatty acid esters | 0.01% to 0.5% | 0.001% to 0.75% |
| Triacetin | 0.010% to 0.5% | 0.001% to 0.75% |
| Dibutyl sebacate | 0.010% to 0.5% | 0.001% to 0.75% |
| Polyglyceryl-fatty acids | 0.01% to 0.5% | 0.001% to 0.75% |
| Polyoxyethylene-fatty acid | 0.01% to 0.5% | 0.001% to 0.75% |
| ethers | | |

*All concentrations are approximate and can be 10% greater or less than the value provided.

### Complexing and Cross Linking Component

The Complexing and cross linking component is any molecule that can be used to allow the film to form a matrix that stretches and/or adds strength to the 5 film. Exemplary ingredients that can be used as complexing and cross linking components include calcium acetate, calcium chloride, Zinc chloride, magnesium chloride, ferric chloride, manganese, magnesium and Zinc salts of acetic acid, and combinations of two or more thereof.

The complexing and cross linking component can be used at any concentration that allows the composition to stretch without significant cracking. One of ordinary skill in the art will be able to determine the concentration of the complexing and cross linking component needed for a particular application. Exemplary concentrations of complexing and cross linking components that can be used in the compositions include from about 0.005% to about 10%, from about 0.10% to about 8%, from about 0.30% to about 5%, and from about 0.50% to about 3%. Table 4 provided below contains additional complexing and cross linking components and exemplary concentrations.

TABLE 4
Complexing and cross linking component

| | Exemplary | Exemplary |
|---|---|---|
| Complexing and cross | Concentration | Concentration |
| linking component | Range 1* | Range 2* |
| Calcium acetate | 0.005% to 0.1% | 0.001% to 0.25% |
| Calcium chloride | 0.005% to 0.1% | 0.001% to 0.25% |
| Zinc chloride | 0.005% to 0.1% | 0.001% to 0.25% |
| Magnesium chloride | 0.005% to 0.1% | 0.001% to 0.25% |
| Ferric chloride | 0.005% to 0.1% | 0.001% to 0.25% |
| Magnesium, manganese, and | 0.005% to 0.1% | 0.001% to 0.25% |
| zinc salts of acetic acid | | |

*All concentrations are approximate and can be 10% greater or less than the value provided.

### Hydrophobic Barrier Component

The hydrophobic barrier component is any molecule that can be used to inhibit moisture from crossing the film. Exemplary ingredients include stearic acid, carnauba wax, glyceryl monostearate, monostearin, diglyceryl stearate, stearin, tristearin, mono, di- and triglycerides, butyl stearate, stearyl alcohol, cetyl alcohol, cetostearyl alcohol, palmitic acid, oleic acid, lecithin, metal salts of fatty acids, polysorbates, sorbitan-fatty acid esters, alkylethoxylates, alkylphenoxy ethoxylates, dioctyl sodium sulfosuccinate, alkyl sulfates, alkyl sulfonates, alpha and beta-pinene and pinene homopolymer, polyglyceryl mono, di- and tri-fatty acid esters and ethers, lignin, lignosulfonic acid and it metal salts, bees wax, candelilla wax, ozokerite wax, Shea butter, hard butter, palm oil, palm kernel oil, avocado oil, tallow, lard, coconut oil, hydrogenated vegetable oil, octyl dodecanol, oleyl alcohol, algae oil, hemp oil, poppy seed oil, and combinations of two or more thereof.

The hydrophobic barrier component can be used at any concentration that allows the composition to form a film that is resistant to moisture transfer. One of ordinary skill in the art will be able to determine the concentration of the hydrophobic barrier component needed for a particular application. Exemplary concentrations of hydrophobic barrier components that can be used in the compositions include from about 0.001% to about 25%, from about 2% to about 20%, from about 3% to about 15%, and from about 4% to about 15%. Table 5 provided below contains additional hydrophobic barrier components and exemplary concentrations.

TABLE 5
Hydrophobic barrier component

| | Exemplary | Exemplary |
|---|---|---|
| Hydrophobic Barrier | Concentration | Concentration |
| Component | Range 1* | Range 2* |
| Stearic acid | 0.01% to 0.1% | 0.001% to 0.50% |
| Carnauba wax | 0.01% to 0.1% | 0.001% to 0.50% |
| Glyceryl monostearate | 0.01% to 0.1% | 0.001% to 0.25% |
| Monostearin | 0.01% to 0.1% | 0.001% to 0.25% |
| Diglycerin stearate | 0.01% to 0.1% | 0.001% to 0.25% |
| Stearin | 0.01% to 0.1% | 0.001% to 0.25% |
| Lanolin or acetylated Lanolin | 0.001% to 0.1% | 0.001% to 0.30% |
| Tristearin | 0.01% to 0.1% | 0.001% to 0.25% |
| Mono, di, triglyceride(s) | 0.01% to 0.1% | 0.001% to 0.25% |
| Butyl stearate | 0.001% to 0.1% | 0.001% to 0.25% |
| Stearyl alcohol | 0.001% to 0.1% | 0.001% to 0.25% |
| Cetyl alcohol | 0.002% to 0.1% | 0.001% to 0.30% |
| Cetostearyl alcohol | 0.001% to 0.1% | 0.001% to 0.30% |
| Palmitic acid, Oleic acid, | 0.001% to 0.1% | 0.001% to 0.25% |
| lecithin | | |
| Poly(oxyethylenes) | 0.001% to 0.1% | 0.001% to 0.25% |
| p-nonylphenols | | |
| Polysorbates, | 0.001% to 0.1% | 0.001% to 0.25% |
| Alkylethoxylates, | 0.001% to 0.1% | 0.001% to 0.25% |
| alkylphenoxyethoxylates | | |
| Dioctyl sodium | 0.001% to 0.1% | 0.001% to 0.20% |
| sulfosuccinate | | |
| Alkyl sulfates | 0.001% to 0.1% | 0.001% to 0.25% |
| Alkyl sulfonates | 0.001% to 0.1% | 0.001% to 0.25% |
| Pinene homopolymer | 0.001% to 0.1% | 0.001% to 0.25% |
| Fatty acids and their metal | 0.001% to 0.1% | 0.001% to 0.50% |
| salts, i.e., sodium, potassium, | | |
| zinc, calcium, etc. | | |
| Polyglycerin mono, di and tri | 0.001% to 0.1% | 0.001% to 0.25% |
| fatty acid esters and ethers | | |
| Lignin | 0.001% to 0.1% | 0.001% to 0.30% |
| Lignosulfonic acid and it | 0.001% to 0.1% | 0.001% to 0.30% |
| metal salts | | |
| Beeswax | 0.001% to 0.1% | 0.001% to 0.50% |
| Candelilla wax | 0.001% to 0.1% | 0.001% to 0.50% |
| Ozokerite wax | 0.001% to 0.1% | 0.001% to 0.50% |
| Shea butter | 0.001% to 0.1% | 0.001% to 0.50% |
| Hard butter | 0.001% to 0.1% | 0.001% to 0.50% |
| Palm oil | 0.001% to 0.1% | 0.001% to 0.50% |
| Palm kernel oil | 0.001% to 0.1% | 0.001% to 0.50% |
| Avocado oil | 0.001% to 0.1% | 0.001% to 0.50% |
| Tallow | 0.001% to 0.1% | 0.001% to 0.50% |
| Lard | 0.001% to 0.1% | 0.001% to 0.50% |
| Coconut oil | 0.001% to 0.1% | 0.001% to 0.50% |
| Hydrogenated vegetable oil | 0.001% to 0.1% | 0.001% to 0.50% |
| Octyl dodecanol | 0.001% to 0.1% | 0.001% to 0.50% |
| Oleyl alcohol | 0.001% to 0.1% | 0.001% to 0.30% |
| Algae oil | 0.001% to 0.1% | 0.001% to 0.30% |
| Hemp oil | 0.001% to 0.1% | 0.001% to 0.30% |
| Poppy seed oil | 0.001% to 0.1% | 0.001% to 0.30% |

*All concentrations are approximate and can be 10% greater or less than the value provided.

### Film Forming Matrices Component

The film forming matrices component is any molecule that can be used to allow the composition to form a matrix structure. Exemplary ingredients that can be used include cellulose acetate, cellulose acetate-succinate, cellulose acetate phthalate, hydroxyethylcellulose, hydroxypropylcellulose, carboxymethylcellulose, carboxyethylcellulose, chitosan, methylcellulose, ethyl cellulose, propylcellulose, butylcellulose, alkylcelluloses, phthalate and acetate esters of cellulose, hypromellose, hypromellose acetate succinate, hypromellose phthalate, xanthan gum, guar gum, gellan gum, gum arabic, carageenan, alginic acid (and its salts), acacia, tragacanth, polyvinyl acetate, polyvinyl alcohol, polyvinylpyrolidone, polyvinyl lacetate phthalate, methacrylic-acrylic acid copolymer and its alkyl esters or ethers and combinations of two or more thereof.

The film forming matrices component can be used at any concentration that allows the composition to form a film. One of ordinary skill in the art will be able to determine the concentration of the film forming matrices component needed for a particular application. Exemplary concentrations of film forming matrices components that can be used in the compositions include from about 0.005% to about 10%, from about 0.10% to about 8%, from about 0.30% to about 5%, and from about 0.50% to about 3%. Table 6 provided below contains additional film forming matrices components and exemplary concentrations.

TABLE 6
Film forming matrices component

| | Exemplary | Exemplary |
|---|---|---|
| Film Forming Matrices | Concentration | Concentration |
| Component | Range 1* | Range 2* |
| Cellulose acetate | 0.005% to 0.05% | 0.001% to 0.10% |
| Hydroxyl ethyl cellulose | 0.005% to 0.05% | 0.001% to 0.10% |
| Hydroxyl propyl cellulose | 0.005% to 0.05% | 0.001% to 0.10% |
| Carboxymethylcellulose | 0.005% to 0.05% | 0.001% to 0.10% |
| Chitosan | 0.005% to 0.05% | 0.001% to 0.30% |
| Methylcellulose | 0.005% to 0.05% | 0.001% to 0.10% |
| Ethylcellulose | 0.005% to 0.05% | 0.001% to 0.10% |
| Butylcellulose | 0.005% to 0.05% | 0.001% to 0.10% |
| Alkylcelluloses | 0.005% to 0.05% | 0.001% to 0.10% |
| Phthalate and acetate esters of | 0.005% to 0.05% | 0.001% to 0.10% |
| cellulose | | |
| Hypromellose | 0.005% to 0.05% | 0.001% to 0.15% |
| Propylcellulose | 0.005% to 0.05% | 0.001% to 0.10% |
| Cellulose acetate succinate | 0.005% to 0.05% | 0.001% to 0.15% |
| Hypromellose acetate | 0.005% to 0.05% | 0.001% to 0.15% |
| succinate | | |
| Carboxyethylcellulose | 0.005% to 0.05% | 0.001% to 0.10% |
| Cellulose acetate phthalate | 0.005% to 0.05% | 0.001% to 0.15% |
| Hypromellose phthalate | 0.005% to 0.05% | 0.001% to 0.15% |
| Polyvinylacetate phthalate | 0.005% to 0.05% | 0.001% to 0.15% |
| Xanthan gum | 0.005% to 0.05% | 0.001% to 0.10% |
| Combinations of Xanthan | 0.005% to 0.05% | 0.001% to 0.15% |
| gum with Pectin, Guar | | |
| gum, locust bean gum or | | |
| other gums | | |
| Guar gum | 0.005% to 0.05% | 0.001% to 0.10% |
| Gellan gum | 0.005% to 0.05% | 0.001% to 0.10% |
| Gum Arabic | 0.005% to 0.05% | 0.001% to 0.10% |
| Carageenan | 0.005% to 0.05% | 0.001% to 0.10% |
| Alginic acid (and its salts) | 0.005% to 0.05% | 0.001% to 0.10% |
| Acacia | 0.005% to 0.05% | 0.001% to 0.20% |
| Tragacanth | 0.0005% to 0.05% | 0.0001% to 0.15% |
| Polyvinyl acetate | 0.005% to 0.05% | 0.001% to 0.20% |
| Polyvinyl alcohol | 0.0025% to 0.05% | 0.001% to 0.10% |
| Polyvinylpyrolidone | 0.005% to 0.05% | 0.001% to 0.10% |
| Methacrylic-acrylic acid | 0.0005% to 0.05% | 0.0001% to 0.25% |
| copolymer and its alkyl esters | | |
| or ethers | | |
| Zein | 0.005% to 0.05 | 0.001% to 0.25% |

*All concentrations are approximate and can be 10% greater or less than the value provided.

### UV Protectant Component

The UV protectant component are any molecules that can be used to impart a UV protection quality to the film. Exemplary ingredients include talc, mica, quartz, kaolin, bentonite, attapulgite, smectic clay, montmorillonite, silica, cinnamaldehyde, cinnamic acid, methyl-cinnamate, benzyl cinnamate, octyl methoxy-cinnamate, Zinc oxide, titanium oxide, cinnamic alcohol, menthyl anthranilate, ethyl anthranilate, ethyl p-aminobenzoate, homomenthyl salicylate, benzyl Salicylate, 2-ethylhexyl salicylate, isoamyl salicylate, methyl salicylate, syctonemin, agave cactus plant wax, hippo sweat or a component thereof, and combinations of two or more thereof.

The UV protectant component can be used at any concentration that allows the composition to decrease damage caused by UV rays and/or heat. One of ordinary skill in the art will be able to determine the concentration of the UV protectant component needed for a particular application. Exemplary concentrations of UV protectant components that can be used in the compositions include from about 0.001% to about 15%, from about 0.02% to about 9%, from about 0.05% to about 8%, from about 0.07% to about 7%, from about 0.10% to about 6%, from about 0.15% to about 5%, and any percentages therebetween. Table 7 provided below contains additional UV protectant component and exemplary concentrations.

TABLE 7
UV protectant component

| | Exemplary | Exemplary |
|---|---|---|
| UV Protectant | Concentration | Concentration |
| Component | Range 1* | Range 2* |
| Talc | 0.01% to 0.075% | 0.001 to 0.5% |
| Mica | 0.01% to 0.075% | 0.001% to 0.5% |
| Quartz | 0.01% to 0.075% | 0.01% to 0.5% |
| Kaolin | 0.01% to 0.075% | 0.001% to 0.5% |
| Bentonite | 0.01% to 0.075% | 0.001% to 0.5% |
| Attapulgite | 0.01% to 0.075% | 0.001% to 0.5% |
| Montmorillonite | 0.01% to 0.075% | 0.001% to 0.5% |
| Smectic clay | 0.001% to 0.075% | 0.0001% to 0.5% |
| Silica | 0.001% to 0.075% | 0.0001% to 0.5% |
| Cinnamaldehyde | 0.001% to 0.075% | 0.0001% to 0.20% |
| Cinnamic acid | 0.001% to 0.075% | 0.0001% to 0.20% |
| Methyl-cinnamate | 0.001% to 0.075% | 0.0001% to 0.20% |
| Benzyl cinnamate | 0.001% to 0.075% | 0.0001% to 0.20% |
| Octylmethoxy-cinnamate | 0.001% to 0.05% | 0.0001% to 0.15% |
| Zinc oxide | 0.001% to 0.075% | 0.0001% to 0.5% |
| Titanium Oxide | 0.001% to 0.075% | 0.0001% to 0.5% |
| Cinnamic Alcohol | 0.001% to 0.075% | 0.0001% to 0.20% |
| Menthyl anthranilate | 0.001% to 0.04% | 0.0001% to 0.1% |
| Ethyl anthranilate | 0.001% to 0.04% | 0.0001% to 0.1% |
| Ethyl p-aminobenzoate | 0.001% to 0.075% | 0.0001% to 0.5% |
| Homomenthyl salicylate | 0.001% to 0.075% | 0.0001% to 0.5% |
| Benzyl salicylate | 0.001% to 0.075% | 0.0001% to 0.5% |
| 2-ethylhexyl salicylate | 0.001% to 0.075% | 0.0001% to 0.5% |
| Isoamyl salicylate | 0.001% to 0.075% | 0.0001% to 0.5% |
| Methyl salicylate | 0.001% to 0.075% | 0.0001% to 0.5% |
| Syctonemin | 0.00001% to 0.075% | 0.00001% to 0.5% |
| Agave cactus plant wax | 0.00001% to 0.075% | 0.00001% to 0.5% |
| Hippo sweat or a | 0.00001% to 0.075% | 0.00001% to 0.5% |
| component thereof | | |

*All concentrations are approximate and can be 10% greater or less than the value provided.

### Other Components

In some embodiments, it is desirable to increase the growth rate of the plant including fruits and vegetables. Compositions that are useful for this purpose can contain one or more growth stimulants or plant growth regulators, such as cytokinins up to 4%, gibberellins up to 4%, auxins up to 4%, ethylene (ethephon; Bayer Crop Science), abscisic acid up to 4% or combinations thereof. These concentrations when diluted to produce concentrations in the range of 0.01-0.04% promote growth. When combined together in ratio of 0.85:1.0 up to 1:1 and plants growth stimulants have similar effects but the growth stimulants can be used alone or in combination. If the concentrations of the plant growth stimulants are increased 10 to 100 times from what is listed they can also act as herbicides.

In yet other examples, the composition can include additional nutrients or supplements, such as vitamins and minerals that are useful to the subject eating the plant or plant part. One of ordinary skill in the art will appreciate that such nutrients will vary depending upon the dietary needs of the subject eating the plant or plant part. For instance, when the plant part is a grain for ingestion by livestock different nutrients can be added than when the plant part is intended for human consumption. For example, selenium, zinc, iron, magnesium, manganese, citric acid, beta-carotene, vitamin A, vitamin A acetate, vitamin palmitate, vitamin D, (α-tocopherol, tocopherols, vitamin E, vitamin E acetate, vitamin E palmitate, ascorbic acid, vitamin C, niacin, riboflavin, cyanocobalamin, and other vitamins used at levels recognized by the FDA, and USDA.

In another embodiment, the pest repellent composition may further comprise one or more emulsifiers such as anionic, cationic and nonionic emulsifier, including, but not limited to, Aerosol OT-S, Bioterge AS-40, Rhodacal IPAM, Rhodapex CO-436, Igepal CA-520, Bio-Soft N1-5, Toximul 3463F, Toximul 3465F, Toximul H-A, Toximul 3454F, Toximul 3404F, Teric X8, Surfonic N-100, Alkamuls EL-719, Surfonic OP-100, Bio-Soft N1-9, Surfonic OP-120, Tween 80, Witconol TD-140, Polystep F-9, Bio-Soft N25-3, and Bio-Soft N1-3. Exemplary concentrations of emulsifier in the composition include from about 0.001% to about 15%, from about 0.01% to about 10%, from about 0.02% to about 9%, from about 0.05% to about 8%, from about 0.07% to about 7%, from about 0.10% to about 6%, from about 0.15% to about 5%, and any percentages therebetween. In specific embodiments, the emulsifier is Aersol OT-S, Toximul 3463F, or Toximul 3465F.

In certain embodiments, the repellent composition of the subject invention further comprises an acceptable carrier. The carrier must be acceptable in the sense of being compatible with the other ingredients of the composition. The acceptable carrier may be any suitable carrier known in the art, including, but not limited to, lactose, glucose, sucrose, cellulose and its derivatives (e.g., sodium carboxymethyl cellulose, ethyl cellulose, and cellulose acetate), malt, gelatin, talc, excipients, glycols (e.g., propylene glycol), polyols (e.g., glycerin, sorbitol, mannitol, and poly ethylene glycol), esters (e.g., ethyl oleate and ethyl laurate), agar; buffering agents (e.g., magnesium hydroxide and aluminum hydroxide), alginic acid, pyrogen-free water, isotonic saline, and ethyl alcohol.

In one embodiment, the repellent composition of the subject invention further comprises an oil component such as cinnamon oil, clove oil, cottonseed oil, garlic oil, or rosemary oil; another natural surfactant such as Yucca or Quillaja saponins. Other oils that may be used as an insect repellent component or adjuvants include: almond oil, camphor oil, canola oil, castor oil, cedar oil, citronella oil, citrus oil, coconut oil, corn oil, eucalyptus oil, fish oil, geranium oil, lecithin, lemon grass oil, linseed oil, mineral oil, mint or peppermint oil, olive oil, pine oil, rapeseed oil, safflower oil, sage oils, sesame seed oil, sweet orange oil, thyme oil, vegetable oil, and wintergreen oil.

Further components can be added to the insect repellent composition, including buffering agents, viscosity modifiers, nutrients for plant growth, tracking agents, biocide, emulsifying agents, lubricants, solubility controlling agents, pH adjusting agents, stabilizers and ultra-violet (UV) light resistant agents. In some instances, a particular ingredient performs the function of more than one component. In other instances, multiple ingredients that fall into a component category are used in the composition.

In one embodiment, the composition can further comprise buffering agents, including organic and amino acids or their salts, to stabilize pH near a preferred value. Suitable buffers include, but are not limited to, citrate, gluconate, tartarate, malate, acetate, lactate, oxalate, aspartate, malonate, glucoheptonate, pyruvate, galactarate, glucarate, tartronate, glutamate, glycine, lysine, glutamine, methionine, cysteine, arginine and mixtures thereof. Phosphoric and phosphorous acids or their salts may also be used. Synthetic buffers are suitable to be used but it is preferable to use natural buffers such as organic and amino acids or their salts.

In a further embodiment, pH adjusting agents include potassium hydroxide, ammonium hydroxide, potassium carbonate or bicarbonate, hydrochloric acid, nitric acid, sulfuric acid and mixtures thereof. The pH of the insect repellent composition should be suitable for the plant of interest. In a preferred embodiment, the pH of the final composition ranges from 6.0-8.0, preferably, 7.0-7.5.

In one embodiment, additional components such as an aqueous preparation of a salt, such as sodium bicarbonate or carbonate, sodium sulfate, sodium phosphate, or sodium biphosphate, can be included in the composition.

In one embodiment, antioxidants may be included in the compositions. Antioxidants can be used to protect post harvest fruit and vegetables from browning caused by oxidation. Exemplary antioxidants include EDTA, glutathione, α-tocopherol, tocopherols, vitamin E, vitamin E acetate, vitamin E palmitate, zinc glycinate, ascorbic acid and its salts of calcium, sodium, and potassium, ascorbyl palmitate, calcium citrate, BHA, BHT, guaiac extract, gallic acid and methyl, ethyl, propyl, dodecyl esters of gallic acid, phosphatidylcholine, propionic acid, sucrose, cyclodextrins, rosemary, and cysteine hydrochloride. These antioxidants can be used at a concentration of from about 0.01 to about 1.0%.

In one embodiment, additional components can be included to increase the efficacy of the treatment products, such as chelator/chelating agents and adherents. As used herein, “chelator” or “chelating agent” means an active agent capable of removing a metal ion from a system by forming a complex so that the metal ion cannot readily participate in or catalyze oxygen radical formation.

Examples of chelating agents suitable for the present invention include, but are not limited to, dimercaptosuccinic acid (DMSA), 2,3-dimercaptopropanesulfonic acid (DMPS), alpha lipoic acid (ALA), thiamine tetrahydrofurfuryl disulfide (TTFD), penicillamine, ethylenediaminetetraacetic acid (EDTA), and citric acid.

The compositions may comprise various combinations of compounds described above as well as varying concentrations of the compound depending upon the insect to be repelled. Typically the active ingredient compound of the disclosure will be present in the composition in a concentration of at least about 0.0001% (w/v) and may be 10, 50, 90 or 100% (w/v) of the total composition. Exemplary concentrations of the active ingredients in the insect repellent compositions include from about 0.0001% to about 90%, from about 0.0005% to about 85%, from about 0.001% to about 80%, from about 0.005% to about 75%, from about 0.01% to about 70%, from about 0.05% to about 65%, from about 0.1% to about 60%, from about 0.1% to about 55%, from about 0.1% to about 50%, from about 0.1% to about 45%, from about 0.1% to about 40%, from about 0.5% to about 40%, from about 1% to about 40%, from about 2% to about 40%, from about 5% to about 40%, from about 10% to about 40%, and any percentages therebetween. The repellent carrier may be from 0.0001% to 99.9999% (w/v) of the total composition.

In some embodiments, the repellent composition according to the subject invention does not contain surfactants.

In certain embodiments, the repellent composition comprises one or more microorganisms or growth by-product of the microorganisms. Upon application, the repellent composition forms a more effective and protective exogenous film comprising the microorganisms or by-products of microbial growth. The microorganisms according to the subject invention can be, for example, bacteria, yeast, fungi or multicellular organisms. In one embodiment, the microorganism according to the subject invention are “probiotic,” which, when administered in adequate amounts, confer a health benefit on the host. In preferred embodiments, the microorganisms are live.

In one embodiment, the composition may comprise the microbes themselves and/or by-products of microbial growth. The cells may be in a vegetative state or in spore form, or a mixture of both. The cells may be planktonic or in a biofilm form, or a mixture of both. The cells may be intact or lysed. In preferred embodiments, the cells are in the vegetative state and are present, with broth in which they were grown. The cells may be present at, for example, a concentration of 1×10³, 1×10⁴, 1×10⁵, 1×10⁶, 1×10⁷, 1×10⁸, 1×10⁹, 1×10¹⁰, or 1×10¹¹ or more cells per milliliter of the composition.

In one embodiment, the microorganisms are bacteria, including gram-positive and gram-negative bacteria. These bacteria may be, but are not limited to, for example, Escherichia coli, Rhizobium (e.g., Rhizobium japonicum, Sinorhizobium meliloti, Sinorhizobium fredii, Rhizobium leguminosarum biovar trifolii, and Rhizobium etli), Bradyrhizobium (e.g., Bradyrhizobium japanicum, and B. parasponia), Bacillus (e.g., Bacillus subtilis, Bacillus firmus, Bacillus laterosporus, Bacillus megaterium, Bacillus amyloliquifaciens), Azobacter (e.g., Azobacter vinelandii, and Azobacter chroococcum), Arhrobacter (e.g. Agrobacterium radiobacter), Pseudomonas (e.g., Pseudomonas chlororaphis subsp. aureofaciens (Kluyver)), Azospirillium (e.g., Azospirillumbrasiliensis), Azomonas, Derxia, Beijerinckia, Nocardia, Klebsiella, Clavibacter (e.g., C. xyli subsp. xyli and C. xyli subsp. cynodontis), cyanobacteria, Pantoea (e.g., Pantoea agglomerans), Sphingomonas (e.g., Sphingomonas paucimobilis), Streptomyces (e.g., Streptomyces griseochromogenes, Streptomyces qriseus, Streptomyces cacaoi, Streptomyces aureus, and Streptomyces kasugaenis), Streptoverticillium (e.g., Streptoverticillium rimofaciens), Ralslonia (e.g., Ralslonia eulropha), Rhodospirillum (e.g., Rhodospirillum rubrum), Xanthomonas (e.g., Xanthomonas campestris), Erwinia (e.g., Erwinia carotovora), Clostridium (e.g., Clostridium bravidaciens, and Clostridium malacusomae) and combinations thereof.

In one embodiment, the microorganism is a fungus (including yeast), including, but not limited to, for example, Starmerella, Mycorrhiza (e.g., vesicular-arbuscular mycorrhizae (VAM), arbuscular mycorrhizae (AM)), Mortierella, Phycomyces, Blakeslea, Thraustochytrium, Penicillium, Phythium, Entomophthora, Aureobasidium pullulans, F usarium venenalum, Aspergillus, Trichoderma (e.g., Trichoderma reesei, T. harzianum, T. viride and T. hamatum), Rhizopus spp, endophytic fungi (e.g., Piriformis indica), Saccharomyces (e.g., Saccharomyces cerevisiae, Saccharomyces boulardii sequela and Saccharomyces torula), Debaromyces, Issalchenkia, Kluyveromyces (e.g., Kluyveromyces lactis, Kluyveromyces fragilis), Pichia spp (e.g., Pichia pastoris), and combinations thereof.

In one embodiment, the by-products of microbe growth may be, for example, metabolites, cell membrane components, expressed proteins, and/or other cellular components. A “metabolite” refers to any substance produced by metabolism or a substance necessary for taking part in a particular metabolic process. A metabolite can be an organic compound that is a starting material (e.g., glucose), an intermediate (e.g., acetyl-CoA) in, or an end product (e.g., n-butanol) of metabolism. Examples of metabolites include, but are not limited to, enzymes, toxins, acids, solvents, alcohols, proteins, vitamins, minerals, microelements, amino acids, polymers, and surfactants. In one embodiment, the fermentation product is spinosad.

In one embodiment, the growth by-products are biosurfactants. In certain embodiments, the biosurfactants comprise a blend of one or more glycolipids and/or one or more lipopeptides. In specific embodiments, the glycolipids include rhamnolipids (RLP), sophorolipids (SLP), trehalose lipids and mannosylerythritol lipids (MEL), and the lipopeptides include surfactin, iturin A, fengycin and/or lichenysin.

### Formulation and Application

The compositions described herein can be made using any method known in the art that produces a composition that forms a film on surfaces such as plants and plant parts. In some embodiments, the compositions are dispersions or emulsions. The dispersions or emulsions can be created by mixing the ingredients simultaneously. In other embodiments, the components are added while continuously mixing and in yet other examples the components are added in a specific order with or without the addition of heat. One of ordinary skill in the art will appreciate that the method of mixing will depend in part upon the ambient temperature and pressure and the components chosen for inclusion in the composition as well as their relative amounts.

As used herein, “mixing” can be accomplished by any means known in the art. For example, mechanically stirring, agitating or co-spraying components can be used to “mix” the components described herein. The resulting product will form a dispersion or an emulsion.

In embodiments where the composition is not intended for immediate use, for example when the composition is packaged for future sale, the dispersion or emulsion is shelf stable. For example, less than 20%, 30%, 40% or 50% of the dispersion or emulsion will separate after 5, 10, 20, 30 or 60 days of storage. Even longer periods of storage are also contemplated. One of ordinary skill in the art will appreciate that methods of making shelf-stable dispersions and emulsions involve choosing appropriate emulsifiers and mixing the components to achieve the desired particle size.

In other embodiments, the composition is applied relatively soon after mixing so the creation of a stable emulsion is not necessary. In some embodiments, the subcomponents of the composition can be premixed, for example the oil and oil soluble components can be mixed into a first composition and the water and water soluble components can be mixed into a second composition. The resulting two compositions can be then mixed on or near the location where application will occur, thus eliminating the need to create a shelf stable emulsion.

In some embodiments, the formulation may be slightly off-white to yellow. The viscosity was from about 20,000 to about 23,000 centipoise. The viscosity decreased upon storage to about 15,000 centipoise. The micelle had a very wide size range. The micelle globules being in the nanometer range to the micrometer size.

The insect repellent composition may be formulated in a variety of ways, including gas, liquid, solids, granular, dust, or slow release products by means that will be understood by those of skill in the art having the benefit of the instant disclosure.

Solid formulations of the invention may have different forms and shapes such as cylinders, rods, blocks, capsules, tablets, pills, pellets, strips, spikes, etc. Solid formulations may also be milled, granulated or powdered. The granulated or powdered material may be pressed into tablets or used to fill pre-manufactured gelatin capsules or shells. Semi solid formulations can be prepared in paste, wax, gel, or cream preparations.

The solid or semi-solid compositions of the invention can be coated using film-coating compounds used in the pharmaceutical industry such as polyethylene glycol, gelatin, sorbitol, gum, sugar or polyvinyl alcohol. This is particularly essential for tablets or capsules used in such formulations. Film coating can protect the handler from coming in direct contact with the active ingredient in the formulations.

The concentrations of the ingredients in the formulations and application rate of the compositions may be varied widely depending on the pest, plant or area treated, or method of application.

Liquid formulations may be aqueous-based or non-aqueous (e.g., organic solvents), or combinations thereof, and may be employed as lotions, foams, gels, suspensions, emulsions, microemulsions or emulsifiable concentrates or the like.

The dry formulations will have from about 0.0001-95% by weight of the pesticide while the liquid formulations will generally have from about 0.0001-60% by weight of the solids in the liquid phase.

In other embodiments, the composition can be placed in containers of appropriate size, taking into consideration, for example, the intended use, and the contemplated method of application. Thus, the containers into which the composition is placed may be, for example, from 1 mL to 1000 gallons or more. In other embodiments the containers are 50 mL, 200 mL, or larger. In other embodiments the containers are 2 gallons, 5 gallons, 25 gallons, or larger.

The repellent compositions described herein can be applied to plants and plant parts in the field using any method known in the art. In some embodiments, the compositions are painted or injected onto the plants or plant parts. For example, the compositions can be sprayed onto trees, bushes, vines, vegetable plants, ornamental and decorative plants such as plants grown for their flowers (e.g., roses) or for their decorative foliage (e. g., ivy), and the like. In one embodiment, the insect repellents of the subject invention may be applied, for example, through an irrigation system, as a spray, for example, from a backpack or similar devices, as a seed treatment, to the soil surface, and/or to plant surfaces. Mechanical application through conventional implements or robotic application through aerial or ground based “drones” is also facilitated.

The timing and volume of the composition applied will vary depending upon the desired activity of the composition. For example, to generally protect the plant from pest biting or settling, the composition can be applied at any time and reapplied as necessary. In same embodiments, the insect repellent composition according to the subject invention may be applied to the plant or crop from about 1 to about 100 days, about 2 to about 50 days, about 10 to about 40 days, about 20 to about 30 days.

In certain embodiments, the pest repellent compositions may be diluted before field application. Exemplary application rates include from about one gallon (˜4 L) diluted to 100 gallons with water and the 100 gallons is sprayed on one acre of fruit trees. The compositions can be also diluted to 200 gallons and up to 200 gallons of water can be applied per acre.

To protect fruits and vegetables from sun damage and/or moisture-induced cracking the application rate will vary depending upon the surface area needed to be protected and the variety and density of planting. Generally, from about 4 L/acre to about 400 L/acre (based on water amount) can be applied, however, care should be taken not to provide too much water such that cracking and other problems are created. When applying the compositions to plants or plant parts the composition can be applied at any time in the growth cycle.

In some embodiments, the composition can be applied prior to harvest. For example the compositions can be applied up to about 1, 5, 10, 15, 20, 25, 30, 35 or 40 days before harvest. For sun burn protection applying after the fruit is set and then monthly thereafter can provide good results. In another embodiment, when cherries are being protected the first application can be applied after straw color appears and again 10 days before harvest or under heavy rain conditions reapplying four weeks before harvest and again 10 days before harvest. The product can be applied weekly if necessary before harvest. The composition can be also applied three weeks after harvest for sunburn protection.

The plant parts can be contacted or applied to with the compositions described herein prior to being harvested and/or after harvesting (i.e., post-harvest). In some embodiments, the composition is applied or re-applied post-harvest. Post harvest applications can function to prevent cracking during processing, reduce over ripening, moisture loss and infestation. In some embodiments, post harvest application is done within 1 day, 2 days, 5 days, 7 days or 10 days after harvest. In some embodiments, the post harvest plant part is dipped or enrobed in the composition. Traditional methods of storing plant parts can be used. For example, the plant parts can be stored using controlled temperatures and humidity. The plant parts can be stored at temperatures of from about 0° C. to about 30° C., from about 5° C. to about 25° C., or from about 10° C. to about 20° C. The plant parts typically can be stored for 5, 10, 15, or 20 days longer than plant parts that have not been contacted with the compositions described herein.

Method of using the Pest Repellent Composition

The compositions described herein can be used to repel pests and enhance the efficiency of creating agricultural based products. This can include, for example, increasing the ease of making products from plants. For example, the use of the compositions can increase efficiency by making downstream processing, such as post harvest processing more efficient (for instance, requiring less labor, time, chemicals, cost etc.). Similarly, enhancing efficiency includes increasing the yield of a product (particularly salable product) per acre or per plant. Increases in productivity can also mean economic productivity such as eliminating or reducing the need for using pesticides, fertilizers, insecticides or other chemicals during the growing cycle.

In one embodiment, the subject invention provides methods for repelling pests from an object or an area which comprises treating the object or area with a repelling effective amount of the pest repellent composition accordingly to the subjection invention. In further embodiments, the object is a plant or a plant part, an animal, or a human. The area may be any surface that in need of repelling insect, for example, crop field, skin, and clothes. In another embodiment, the plant is a citrus plant and the insect is a psyllid, preferable, an ACP.

In one embodiment, the subjection invention provides a method for repelling a pest, comprising applying to a subject an effect amount of the repellent composition to repel the pest. In one embodiment, the subject is a plant, plant part, an animal or a human. Preferably, the subject is a plant or plant part. More preferably, the plant is a citrus plant. In another embodiment, the pest is a psyllid, preferably, an ACP.

The subject invention also provides methods for protecting an agricultural crop against a pest which comprises treating the crop to be protected with an effective amount of the repellent composition. Such treatment includes contacting the plant with the repellent composition comprising, or simply applying the repellent composition to the crop. Such treatment may be applied prior to harvesting. In a further embodiment, the agricultural crop is a plant or a plant part. In another embodiment, the plant is a citrus plant and the insect is a psyllid, preferable, an ACP.

The subject invention provides a method of controlling pest attraction to a subject, comprising applying to the subject an effect amount of the repellent composition to control the attraction to said subject. In one embodiment, the subject is a plant, plant part, an animal or a human. Preferably, the subject is a plant or plant part. More preferably, the plant is a citrus plant. In a further embodiment, the insect is a psyllid such as ACP.

In one embodiment, this subject invention provides a method of inhibiting, preventing or reducing the incidence of pest-borne disease in a subject, comprising applying to the subject an effect amount of the pest repellent composition, wherein the settling or attraction of an infected pest to said subject is inhibited, thereby inhibiting, preventing or reducing the incidence of pest-borne disease in said subject. In one embodiment, the subject is a plant, plant part, an animal or a human. Preferably, the subject is a plant or plant part. More preferably, the plant is a citrus plant. In a preferred embodiment, the insect is a psyllid such as an ACP, and the disease is HLB.

In one embodiment, the subject invention provides methods for protecting fruits and vegetables from decay caused by insect attack after harvesting, which comprises harvesting a fruit or vegetable, treating the fruit or vegetable with an effective amount of the insect repellent composition. In a further embodiment, the fruit is a citrus fruit and the insect is a psyllid such as an ACP.

In another embodiment, the subject invention provides methods for extending shelf life of fresh fruits and vegetables which comprises treating the fruits and vegetables with an effective amount of the composition after harvesting. In a further embodiment, the fruit is a citrus fruit.

In some embodiments, the repellent composition can prevent and/or control the growth of microbial pathogens on the plant or plant part. In one embodiment, the repellent composition can improve the performance of other agents that protect the plant or plant part from diseases caused by insects or various plant pathogens. These agents may be natural, e.g., microbes and/or the growth by-products of microbes.

In one embodiment, the subject invention provides methods for controlling and/or treating various plant pathogens, which can be particularly useful for food crops. In another embodiment, the subject invention also provides methods for improving the efficiency of controlling and/or treating various plant pathogens.

Examples of viral infections affecting plants, against which the subject invention is useful, include, but are not limited to, Carlavirus, Abutilon, Hordeivirus, Potyvirus, Mastrevirus, Badnavirus, Reoviridae Fijivirus, Oryzavirus, Phytoreovirus, Mycoreovirus, Rymovirus, Tritimovirus, Ipomovirus, Bymovirus, Cucumovirus, Luteovirus, Begomovirus, Rhabdoviridae, Tospovirus, Comovirus, Sobemovirus, Nepovirus, Tobravirus, Benyvirus, Furovirus, Pecluvirus; Pomovirus; all forms of mosaic virus; beet mosaic virus; cassava mosaic virus; cowpea mosaic virus; cucumber mosaic virus; panicum mosaic satellite virus; plum pox virus; squash mosaic virus; tobacco mosaic virus; tulip breaking virus; and zucchini yellow mosaic virus

Examples of bacterial infections affecting plants, against which the subject invention is useful, include, but are not limited to, Pseudomonas (e.g., P. savastanoi, Pseudomonas syringae pathovars); Ralstonia solanacearum; Agrobacterium (e.g., A. tumefaciens); Xanthomonas (e.g., X. oryzae pv. oryzae; X. campestris pathovars; X. axonopodis pathovars); Erwinia (e.g., E. amylovora); Xylella (e.g., X. fastidiosa); Dickeya (e.g., D. dadantii and D. solani); Pectobacterium (e.g., P. carotovorum and P. atrosepticum); Clavibacter (e.g., C. michiganensis and C. sepedonicus); Candidatus Liberibacter asiaticus; Pantoea; Ralstonia; Burkholderia; Acidovorax; Streptomyces; Spiroplasma; Phytoplasma; huanglongbing (HLB, citrus greening disease); citrus canker disease, citrus bacterial spot disease, citrus variegated chlorosis, citrus food and root rot, and citrus black spot disease.

### Target Plants

The subject invention can be useful for repelling insects, for example, from settling or damaging plants. Preferably, the plants are crop plants.

As used herein, “crop plants” refer to any species of plant or alga edible by humans or used as a feed for animals or fish or marine animals, or consumed by humans, or used by humans (e.g., natural pesticides), or viewed by humans (e.g., flowers, trees) or any plant or alga, or a part thereof, used in industry or commerce or education.

Plants that can benefit from application of the products and methods of the subject invention include: Row Crops (e.g., Corn, Soy, Sorghum, Peanuts, Potatoes, etc.), Field Crops (e.g., Alfalfa, Wheat, Grains, etc.), Tree Crops (e.g., Walnuts, Almonds, Pecans, Hazelnuts, Pistachios, etc.), Citrus Crops (e.g., orange, lemon, grapefruit, etc.), Fruit Crops (e.g., apples, pears, etc.), Turf Crops, Ornamentals Crops (e.g., Flowers, vines, etc.), Vegetables (e.g., tomatoes, carrots, etc.), Vine Crops (e.g., Grapes, Strawberries, Blueberries, Blackberries, etc.), Forestry (e.g., pine, spruce, eucalyptus, poplar, etc.), Managed Pastures (any mix of plants used to support grazing animals).

In specific preferred embodiments, the crop plant is a citrus plant. Examples of citrus plants according to the subject invention include, but are not limited to, orange trees; lemon trees, lime trees and/or grapefruit trees. Other examples include Citrus maxima (Pomelo), Citrus medica (Citron), Citrus micrantha (Papeda), Citrus reticulata (Mandarin orange), Citrus paradisi (grapefruit), Citrus japonica (kumquat), Citrus australasica (Australian Finger Lime), Citrus australis (Australian Round lime), Citrus glauca (Australian Desert Lime), Citrus garrawayae (Mount White Lime), Citrus gracilis (Kakadu Lime or Humpty Doo Lime), Citrus inodora (Russel River Lime), Citrus warburgiana (New Guinea Wild Lime), Citrus wintersii (Brown River Finger Lime), Citrus halimii (limau kadangsa, limau kedut kera), Citrus indica (Indian wild orange), Citrus macroptera, and Citrus latipes, Citrus x aurantiifolia (Key lime), Citrus x aurantium (Bitter orange), Citrus x latifolia (Persian lime), Citrus x limon (Lemon), Citrus x limonia (Rangpur), Citrus x sinensis (Sweet orange), Citrus x tangerina (Tangerine), Imperial lemon, tangelo, orangelo, tangor, kinnow, kiyomi, Minneola tangelo, oroblanco, ugli, Buddha's hand, citron, bergamot orange, blood orange, calamondin, clementine, Meyer lemon, and yuzu.

In some embodiments, the crop plant is a relative of a citrus plant, such as orange jasmine, limeberry, and trifoliate orange (Citrus trifolata).

Further plants according to the invention include all plants that belong to the superfamily Viridiplantae, in particular monocotyledonous and dicotyledonous plants including fodder or forage legumes, ornamental plants, food crops, trees or shrubs selected from Acer spp., Actinidia spp., Abelmoschus spp., Agave sisalana, Agropyron spp., Agrostis stolonifera, Allium spp., Amaranthus spp., Ammophila arenaria, Ananas comosus, Annona spp., Apium graveolens, Arachis spp, Artocarpus spp., Asparagus officinalis, Avena spp. (e.g., Avena sativa, Avena fatua, Avena byzantina, Avena fatua var. sativa, Avena hybrida), Averrhoa carambola, Bambusa sp., Benincasa hispida, Bertholletia excelsea, Beta vulgaris, Brassica spp. (e.g., Brassica napus, Brassica rapa ssp. [canola, oilseed rape, turnip rape]), Cadaba farinosa, Camellia sinensis, Canna indica, Cannabis sativa, Capsicum spp., Carex elata, Carica papaya, Carissa macrocarpa, Carya spp., Carthamus tinctorius, Castanea spp., Ceiba pentandra, Cichorium endivia, Cinnamomum spp., Citrullus lanatus, Citrus spp., Cocos spp., Coffea spp., Colocasia esculenta, Cola spp., Corchorus sp., Coriandrum sativum, Corylus spp., Crataegus spp., Crocus sativus, Cucurbita spp., Cucumis spp., Cynara spp., Daucus carota, Desmodium spp., Dimocarpus longan, Dioscorea spp., Diospyros spp., Echinochloa spp., Elaeis (e.g., Elaeis guineensis, Elaeis oleifera), Eleusine coracana, Eragrostis tef, Erianthus sp., Eriobotrya japonica, Eucalyptus sp., Eugenia uniflora, Fagopyrum spp., Fagus spp., Festuca arundinacea, Ficus carica, Fortunella spp., Fragaria spp., Ginkgo biloba, Glycine spp. (e.g., Glycine max, Soja hispida or Soja max), Gossypium hirsutum, Helianthus spp. (e.g., Helianthus annuus), Hemerocallis fulva, Hibiscus spp., Hordeum spp. (e.g., Hordeum vulgare), Ipomoea batatas, Juglans spp., Lactuca sativa, Lathyrus spp., Lens culinaris, Linum usitatissimum, Litchi chinensis, Lotus spp., Luffa acutangula, Lupinus spp., Luzula sylvatica, Lycopersicon spp. (e.g., Lycopersicon esculentum, Lycopersicon lycopersicum, Lycopersicon pyriforme), Macrotyloma spp., Malus spp., Malpighia emarginata, Mammea americana, Mangifera indica, Manihot spp., Manilkara zapota, Medicago sativa, Melilotus spp., Mentha spp., Miscanthus sinensis, Momordica spp., Morus nigra, Musa spp., Nicotiana spp., Olea spp., Opuntia spp., Ornithopus spp., Oryza spp. (e.g., Oryza sativa, Oryza latifolia), Panicum miliaceum, Panicum virgatum, Passiflora edulis, Pastinaca sativa, Pennisetum sp., Persea spp., Petroselinum crispum, Phalaris arundinacea, Phaseolus spp., Phleum pratense, Phoenix spp., Phragmites australis, Physalis spp., Pinus spp., Pistacia vera, Pisum spp., Poa spp., Populus spp., Prosopis spp., Prunus spp., Psidium spp., Punica granatum, Pyrus communis, Quercus spp., Raphanus sativus, Rheum rhabarbarum, Ribes spp., Ricinus communis, Rubus spp., Saccharum spp., Salix sp., Sambucus spp., Secale cereale, Sesamum spp., Sinapis sp., Solanum spp. (e.g., Solanum tuberosum, Solanum integrifolium or Solanum lycopersicum), Sorghum bicolor, Spinacia spp., Syzygium spp., Tagetes spp., Tamarindus indica, Theobroma cacao, Trifolium spp., Tripsacum dactyloides, Triticosecale rimpaui, Triticum spp. (e.g., Triticum aestivum, Triticum durum, Triticum turgidum, Triticum hybernum, Triticum macha, Triticum sativum, Triticum monococcum or Triticum vulgare), Tropaeolum minus, Tropaeolum majus, Vaccinium spp., Vicia spp., Vigna spp., Viola odorata, Vitis spp., Zea mays, Zizania palustris, Ziziphus spp., amongst others.

Further examples of plants of interest include, but are not limited to, corn (Zea mays), Brassica sp. (e.g., B. napus, B. rapa, B. juncea), particularly those Brassica species useful as sources of seed oil, alfalfa (Medicago sativa), rice (Oryza sativa), rye (Secale cereale), sorghum (Sorghum bicolor, Sorghum vulgare), millet (e.g., pearl millet (Pennisetum glaucum), proso millet (Panicum miliaceum), foxtail millet (Setaria italica), finger millet (Eleusine coracana)), sunflower (Helianthus annuus), safflower (Carthamus tinctorius), wheat (Triticum aestivum), soybean (Glycine max), tobacco (Nicotiana tabacum), potato (Solanum tuberosum), peanuts (Arachis hypogaea), cotton (Gossypium barbadense, Gossypium hirsutum), sweet potato (Ipomoea batatus), cassava (Manihot esculenta), coffee (Coffea spp.), coconut (Cocos nucifera), pineapple (Ananas comosus), citrus trees (Citrus spp.), cocoa (Theobroma cacao), tea (Camellia sinensis), banana (Musa spp.), avocado (Persea americana), fig (Ficus casica), guava (Psidium guajava), mango (Mangifera indica), olive (Olea europaea), papaya (Carica papaya), cashew (Anacardium occidentale), macadamia (Macadamia integrifolia), almond (Prunus amygdalus), sugar beets (Beta vulgaris), sugarcane (Saccharum spp.), oats, barley, vegetables, ornamentals, and conifers.

Vegetables include tomatoes (Lycopersicon esculentum), lettuce (e.g., Lactuca sativa), green beans (Phaseolus vulgaris), lima beans (Phaseolus limensis), peas (Lathyrus spp.), and members of the genus Cucumis such as cucumber (C. sativus), cantaloupe (C. cantalupensis), and musk melon (C. melo). Ornamentals include azalea (Rhododendron spp.), hydrangea (Macrophylla hydrangea), hibiscus (Hibiscus rosasanensis), roses (Rosa spp.), tulips (Tulipa spp.), daffodils (Narcissus spp.), petunias (Petunia hybrida), carnation (Dianthus caryophyllus), poinsettia (Euphorbia pulcherrima), and chrysanthemum. Conifers that may be employed in practicing the embodiments include, for example, pines such as loblolly pine (Pinus taeda), slash pine (Pinus elliotii), ponderosa pine (Pinus ponderosa), lodgepole pine (Pinus contorta), and Monterey pine (Pinus radiata); Douglas-fir (Pseudotsuga menziesii); Western hemlock (Tsuga canadensis); Sitka spruce (Picea glauca); redwood (Sequoia sempervirens); true firs such as silver fir (Abies amabilis) and balsam fir (Abies balsamea); and cedars such as Western red cedar (Thuja plicata) and Alaska yellow-cedar (Chamaecyparis nootkatensis). Plants of the embodiments include crop plants (for example, corn, alfalfa, sunflower, Brassica, soybean, cotton, safflower, peanut, sorghum, wheat, millet, tobacco, etc.), such as corn and soybean plants.

Turfgrasses include, but are not limited to: annual bluegrass (Poa annua); annual ryegrass (Lolium multiflorum); Canada bluegrass (Poa compressa); Chewings fescue (Festuca rubra); colonial bentgrass (Agrostis tenuis); creeping bentgrass (Agrostis palustris); crested wheatgrass (Agropyron desertorum); fairway wheatgrass (Agropyron cristatum); hard fescue (Festuca longifolia); Kentucky bluegrass (Poa pratensis); orchardgrass (Dactylis glomerate); perennial ryegrass (Lolium perenne); red fescue (Festuca rubra); redtop (Agrostis alba); rough bluegrass (Poa trivialis); sheep fescue (Festuca ovine); smooth bromegrass (Bromus inermis); tall fescue (Festuca arundinacea); timothy (Phleum pretense); velvet bentgrass (Agrostis canine); weeping alkaligrass (Puccinellia distans); western wheatgrass (Agropyron smithii); Bermuda grass (Cynodon spp.); St. Augustine grass (Stenotaphrum secundatum); zoysia grass (Zoysia spp.); Bahia grass (Paspalum notatum); carpet grass (Axonopus affinis); centipede grass (Eremochloa ophiuroides); kikuyu grass (Pennisetum clandesinum); seashore paspalum (Paspalum vaginatum); blue gramma (Bouteloua gracilis); buffalo grass (Buchloe dactyloids); sideoats gramma (Bouteloua curtipendula).

Further plants of interest include Cannabis (e.g., sativa, indica, and ruderalis) and industrial hemp.

Plants of interest include grain plants that provide seeds of interest, oil-seed plants, and leguminous plants. Seeds of interest include grain seeds, such as corn, wheat, barley, rice, sorghum, rye, millet, etc. Oil-seed plants include cotton, soybean, safflower, sunflower, Brassica, maize, alfalfa, palm, coconut, flax, castor, olive etc. Leguminous plants include beans and peas. Beans include guar, locust bean, fenugreek, soybean, garden beans, cowpea, mungbean, lima bean, fava bean, lentils, chickpea, etc.

### EXAMPLES

A greater understanding of the present invention and of its many advantages may be had from the following examples, given by way of illustration. The following examples are illustrative of some of the methods, applications, embodiments and variants of the present invention. They are, of course, not to be considered as limiting the invention. Numerous changes and modifications can be made with respect to the invention.

### Example 1

Development of insect repellent composition comprising anthranilate esters. Insect repellent composition comprising butyl anthranilate was developed according to the subject invention. For example, methyl or butyl anthranilate can be formulated in any of Formulae A-S.

TABLE 8
Formulae A-D

| | Formula A | Formula B | Formula C | Formula D |
|---|---|---|---|---|
| Components | Percentage | Percentage | Percentage | Percentage |
| Stearic Acid | 7.5 | 7.5 | 7.5 | 7.5 |
| Lecithin | 5.0 | 2.5 | 5.0 | 5 |
| Hypromellose (HPMC) | 0.0 | 1.0 | — | — |
| Potassium Silicate | 1.0 | 1.0 | 1.0 | 1.0 |
| (29.1% solution) | | | | |
| Isopropyl myristate | — | — | — | 13.0 |
| Glycerin | 20.0 | 20.0 | 20.0 | 2.0 |
| Methyl parabens | 0.18 | 0.18 | 0.18 | 0.36 |
| Propyl parabens | 0.02 | 0.02 | 0.02 | 0.04 |
| Water | 66.3 | 65.3 | 64.3 | 69.1 |
| Carboxymethyl Cellulose | — | — | 1.0 | 1.0 |
| Calcium Acetate | — | — | 1.0 | 1.0 |

TABLE 9
Formulae E-H

| | Formula E | Formula F | Formula G | Formula H |
|---|---|---|---|---|
| Components | Percentage | Percentage | Percentage | Percentage |
| Stearic Acid | 7.5 | 7.5 | 7.5 | |
| Glyceryl monostearate | | | | 7.5 |
| Lecithin | 5.0 | 5.0 | 5 | |
| Polyglyceryl-3-Oleate | | | | 5.0 |
| Hypromellose (HPMC) | 0.0 | 1.0 | — | |
| Methylcellulose | | | | 1.0 |
| Potassium Silicate | 1.0 | 1.0 | 1.0 | |
| (29.1% solution) | | | | |
| Aluminum magnesium | | | | 1 |
| Silicate (30% solution) | | | | |
| Glycerin | 20.0 | 20.0 | | |
| 70% sorbitol solution | | | | 20 |
| Methyl parabens | 0.18 | 0.18 | | |
| Propyl parabens | 0.02 | 0.02 | 0.02 | |
| p-chloro-m-xylenol | | | | 0.2 |
| Water | 66.3 | 65.3 | 64.3 | 65.3 |
| Carboxymethyl | — | — | 1 | |
| Cellulose | | | | |
| Calcium propionate or | | | | 1 |
| potassium Acetate | | | | |
| Calcium Acetate | — | — | 1 | |

TABLE 10
Formulae I-L

| | Formula I | Formula J | Formula K | Formula L |
|---|---|---|---|---|
| Components | Percentage | Percentage | Percentage | Percentage |
| Stearic Acid | 7.5 | 7.5 | 7.5 | |
| Cetyl Alcohol | | | | 7.5 |
| Lecithin | 5.0 | 5.0 | 5 | |
| Polyglyceryl-6-stearate | | | | 5.0 |
| Hypromellose (HPMC) | 0.0 | 1.0 | — | |
| Xanthan Gum | | | | 1.0 |
| Potassium Silicate | 1.0 | 1.0 | 1 | 1 |
| 29.1% solution | | | | |
| Glycerin | 20.0 | 20.0 | | |
| Lactic acid | | | | 2 |
| Methyl parabens | 0.18 | 0.18 | 0.18 | |
| Propyl parabens | 0.02 | 0.02 | 0.02 | |
| BHA | | | | 0.5 |
| Water | 66.3 | 65.3 | 64.3 | 82 |
| Carboxymethyl Cellulose | — | — | 1 | |
| Calcium Acetate | — | — | 1 | 1 |

TABLE 11
Formulae M-O

| | Formula M | Formula N | Formula O |
|---|---|---|---|
| Components | Amounts (g) | Amounts (g) | Amounts (g) |
| Stearic acid | 7.5 | — | — |
| Avocado Oil | — | 7.5 | — |
| Palm Oil | — | — | 7.5 |
| Lecithin | 5 | 5 | 5 |
| Isopropyl Myristate | 13 | 13 | 13 |
| Carboxymethylcellulose | 1 | 1 | 1 |
| Potassium Silicate | 1 | 1 | 1 |
| (29.1% solution) | | | |
| Glycerin | 2 | 2 | 2 |
| Methyl Parabens | 0.36 | 0.36 | 0.36 |
| Propyl Parabens | 0.04 | 0.04 | 0.04 |
| Polysorbate 20 | 2.5 | 2.5 | 2.5 |
| Calcium propionate | 1 | 1 | 1 |
| Water | 66.6 | 66.6 | 66.6 |

TABLE 12
Formulae P-S

| | Formula P | Formula Q | Formula R | Formula S |
|---|---|---|---|---|
| Components | % | % | % | % |
| Stearic Acid | 8.0 | — | — | — |
| Cetyl Alcohol | — | 8.0 | — | — |
| Palm Oil | — | — | 8.0 | — |
| Polyglyceryl-6-stearate | — | — | — | 8.0 |
| Polysorbate 20 | 6.5 | 6.5 | 6.5 | 6.5 |
| Polyoxyethylene fatty | 5.0 | 5.0 | 5.0 | 5.0 |
| alcohol mixture | | | | |
| Light silicone oil | 0.5 | 0.5 | 0.5 | 0.5 |
| defoamer | | | | |
| Lecithin | 5.05 | 5.05 | 5.05 | 5.05 |
| Isopropyl Myristate | 14.75 | 14.75 | 14.75 | 14.75 |
| Preservative | 0.25 | 0.25 | 0.25 | 0.25 |
| Glycerine | 2.5 | 2.5 | 2.5 | 2.5 |
| Carboxymethylcellulose | 0.75 | 0.75 | 0.75 | 0.75 |
| Water | 56.69 | 56.69 | 56.69 | 56.69 |

### Example 2

### Pest Repelling Effect

Pest repelling effect of compositions according to the subject invention was tested in choice assays. ACP were released in an arena and given a choice between treated and untreated shoots to determine how the repellent composition affects host selection and settling behavior.

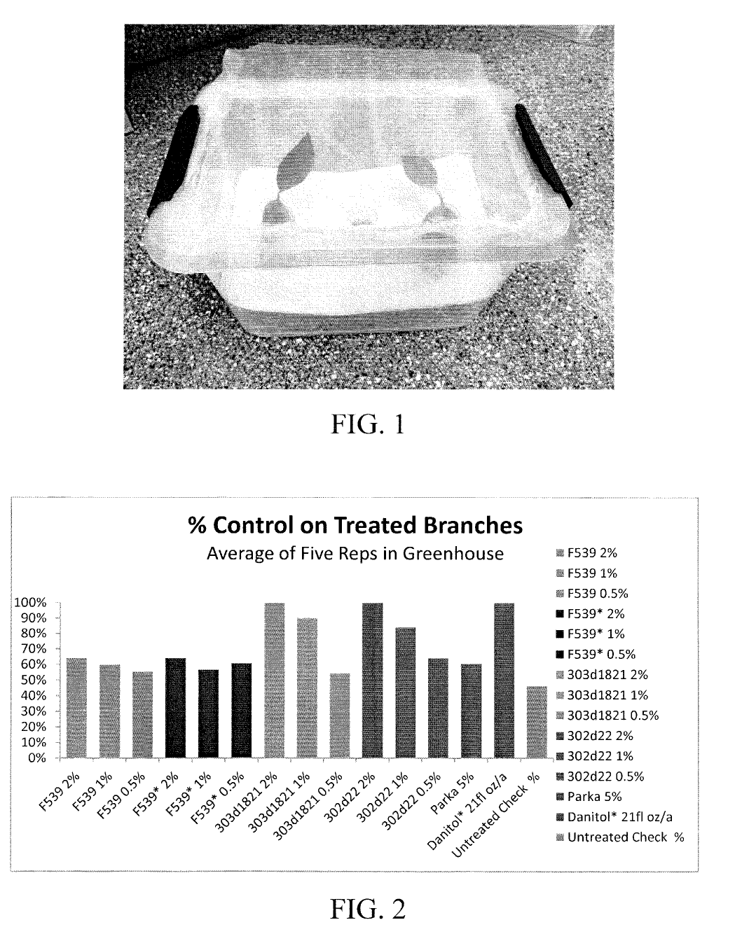

Citrus shoot cuttings were inserted into wet floral foam fitted inside 33 ml clear polystyrene vials to maintain the integrity of the shoots. The vials were sealed using parafilm to prevent floral foam desiccation and psyllid access (FIG. 1).

The choice arena was designed to house three vial inserts. The center vial contained 20 psyllids for release while two peripheral vials held either treated or untreated shoot (FIG. 1).

The treatments are summarized in Table 13 below. The treatments include: 1) the composition of F539 (Butyl Anthranilate at 40%, Vansol 63 at 55%, and Toximul 3463F at 5%); 2) the composition of 302d22 (Ethyl anthranilate 10%); 3) Parka (composition according to the '328 Patent); 4) the composition of 303d1821 (Parka with butyl anthranilate 10%); and 5) Danitol, a highly effective, broad spectrum economical insecticide containing the active ingredient fenpropathrin.

TABLE 13

| Treatment # | Name | Rate | Unit |
|---|---|---|---|
| 1 | F539 | 2 | % ai/v |
| 2 | F539 | 1 | % ai/v |
| 3 | F539 | 0.5 | % ai/v |
| 4 | F539 + DW80 | 2 | % ai/v |
| 5 | F539 + DW80 | 1 | % ai/v |
| 6 | F539 + DW80 | 0.5 | % ai/v |
| 7 | 303d1821 | 2 | % ai/v |
| 8 | 303d1821 | 1 | % ai/v |
| 9 | 303d1821 | 0.5 | % ai/v |
| 10 | 302d22 | 2 | % ai/v |
| 11 | 302d22 | 1 | % ai/v |
| 12 | 302d22 | 0.5 | % ai/v |
| 13 | Parka | 5 | % v/v |
| 14 | Danitol + DW80 | 21 | fl oz/a |
| 15 | Untreated Check | 100 | % v/v |

*ai/v: active ingredient/volume.

The proportion of psyllids that settled on the treated and untreated shoots was documented 24 hours after the release (Tables 14-16). This choice assay was repeated five times for each treatment.

Each replicate was treated on a different day. Mature citrus shoots were cut to two leaves and sprayed to run off with a Badger atomizer operating at 50 PSI with one nozzle. The shoots were allowed to dry and then placed in a sealed box with an untreated shoot set 6 inches away (FIG. 1).

As for the control, both shoots placed in the choice arena were untreated and the results showed that psyllid settlement was even between the two shoots with no preference on one over the other. This justified that the choice assay setup was balanced, and that the significant difference in number of psyllid settlement suggests repellency.

TABLE 14
Living psyllids on treated and untreated shoots

| Trt | Treatment | | Rate | Living on | Living on | Living | Living | Dead | Dead |
|---|---|---|---|---|---|---|---|---|---|
| No. | Name | Rate | Unit | Untreated | Treated | in Cage | in Vial | in Cage | in Vial |
| 1 | F539 | 2% | ai/v | 3.20 a | 4.60 abc | 3.8 a | 3.8 a | 1.4 a | 1.4 a |
| 2 | F539 | 1% | ai/v | 7.72 a | 4.58 abc | 3.4 a | 3.2 a | 1.0 a | 2.2 a |
| 3 | F539 | 0.5% | ai/v | 7.40 a | 6.40 a | 3.6 a | 0.4 a | 0.6 a | 0.8 a |
| 4 | F539 | 2% | ai/v | 6.60 a | 4.00 a-d | 4.0 a | 0.4 a | 0.4 a | 1.0 a |
| | DW80 | 0.125% | v/v | | | | | | |
| 5 | F539 | 1% | ai/v | 4.80 a | 4.80 abc | 3.0 a | 0.6 a | 2.6 a | 1.2 a |
| | DW80 | 0.125% | v/v | | | | | | |
| 6 | F539 | 0.5% | ai/v | 7.80 a | 4.40 abc | 5.2 a | 0.2 a | 1.0 a | 0.2 a |
| | DW80 | 0.125% | v/v | | | | | | |
| 7 | 303d1821 | 2% | ai/v | 7.80 a | 0.00 d | 6.4 a | 0.6 a | 1.2 a | 0.8 a |
| 8 | 303d1821 | 1% | ai/v | 6.40 a | 1.20 cd | 3.6 a | 1.6 a | 1.8 a | 3.6 a |
| 9 | 303d1821 | 0.5% | ai/v | 9.00 a | 5.60 ab | 1.2 a | 1.6 a | 0.4 a | 0.2 a |
| 10 | 302d22 | 2% | ai/v | 10.60 a | 0.00 d | 3.6 a | 0.8 a | 1.6 a | 0.4 a |
| 11 | 302d22 | 1% | ai/v | 9.80 a | 1.00 cd | 3.6 a | 0.6 a | 1.8 a | 0.8 a |
| 12 | 302d22 | 0.5% | ai/v | 9.20 a | 4.20 abc | 4.8 a | 0.6 a | 0.8 a | 0.4 a |
| 13 | Parka | 5% | v/v | 7.20 a | 2.00 bcd | 5.4 a | 0.8 a | 0.2 a | 0.0 a |
| 14 | Danitol | 21 | fl oz/a | 3.80 a | 0.00 d | 6.2 a | 0.8 a | 2.8 a | 2.0 a |
| | DW80 | 0.125% | v/v | | | | | | |
| 15 | Untreated | | | 6.20 a | 5.40 ab | 2.6 a | 1.2 a | 1.0 a | 0.0 a |
| | Check | | | | | | | | |

TABLE 15
Percentage of living psyllids on treated and untreated shoots

| Trt | Treatment | | Rate | Untreated | Treated | Living | Dead | Living | Dead |
|---|---|---|---|---|---|---|---|---|---|
| No. | Name | Rate | Unit | Shoot | Shoot | in Cage | in Cage | in Vial | in Vial |
| 1 | F539 | 2% | ai/v | 19.45% a | 22.60% ab | 22.12% cd | 7.80% abc | 20.31% a | 7.71% bc |
| 2 | F539 | 1% | ai/v | 35.50% a | 33.54% a | 13.59% d | 3.18% c | 9.72% a | 4.46% bc |
| 3 | F539 | 0.5% | ai/v | 39.80% a | 32.95% a | 19.26% d | 2.99% c | 1.67% a | 3.33% bc |
| 4 | F539 | 2% | ai/v | 43.13% a | 23.13% ab | 22.12% cd | 1.82% c | 3.13% a | 6.67% bc |
| | DW80 | 0.125% | v/v | | | | | | |
| 5 | F539 | 1% | ai/v | 29.41% a | 27.41% ab | 20.61% cd | 14.39% ab | 2.73% a | 5.45% bc |
| | DW80 | 0.125% | v/v | | | | | | |
| 6 | F539 | 0.5% | ai/v | 39.94% a | 24.32% ab | 26.99% a-d | 6.51% bc | 1.18% a | 1.05% c |
| | DW80 | 0.125% | v/v | | | | | | |
| 7 | 303d1821 | 2% | ai/v | 45.61% a | 0.00% c | 39.66% abc | 6.71% bc | 3.67% a | 4.36% bc |
| 8 | 303d1821 | 1% | ai/v | 36.25% a | 7.35% bc | 22.25% cd | 9.95% abc | 5.96% a | 18.25% a |
| 9 | 303d1821 | 0.5% | ai/v | 49.18% a | 26.36% ab | 9.03% d | 1.25% c | 12.84% a | 1.33% bc |
| 10 | 302d22 | 2% | ai/v | 59.66% a | 0.00% c | 24.44% bcd | 7.81% abc | 5.71% a | 2.38% bc |
| 11 | 302d22 | 1% | ai/v | 51.14% a | 6.46% bc | 25.39% bcd | 7.95% abc | 5.69% a | 3.37% bc |
| 12 | 302d22 | 0.5% | ai/v | 47.23% a | 19.93% abc | 24.22% bcd | 3.65% c | 3.15% a | 1.82% bc |
| 13 | Parka | 5% | v/v | 35.49% a | 16.19% abc | 41.55% ab | 1.67% c | 5.11% a | 0.00% c |
| 14 | Danitol | 21 | fl oz/a | 23.62% a | 0.00% c | 45.27% a | 16.86% a | 3.90% a | 10.34% ab |
| | DW80 | 0.125% | v/v | | | | | | |
| 15 | Untreated | | | 37.09% a | 33.33% a | 15.90% d | 6.32% bc | 7.35% a | 0.00% c |
| | Check | | | | | | | | |

TABLE 16
Psyllid settling preference on treated and untreated shoots

| Trt | Treatment | | Rate | Living on | Standard | Living on |
|---|---|---|---|---|---|---|
| No. | Name | Rate | Unit | Untreated | Error | Treated |
| 1 | F539 | 2 | % ai/v | 3.20 a | ±0.9 | 4.60 a |
| 2 | F539 | 1 | % ai/v | 5.20 a | ±2.4 | 4.58 a |
| 3 | F539 | 0.5 | % ai/v | 7.40 a | ±2.2 | 6.40 a |
| 4 | F539 | 2 | % ai/v | 6.60 a | ±1.7 | 4.00 a |
| | DW80 | 0.125 | % v/v | | | |
| 5 | F539 | 1 | % ai/v | 4.80 a | ±1.3 | 4.80 a |
| | DW80 | 0.125 | % v/v | | | |
| 6 | F539 | 0.5 | % ai/v | 7.80 a | ±2.6 | 4.40 a |
| | DW80 | 0.125 | % v/v | | | |
| 7 | 303d1821 | 2 | % ai/v | 7.80 a | ±1.3 | 0.00 b |
| 8 | 303d1821 | 1 | % ai/v | 6.40 a | ±1.7 | 1.20 b |
| 9 | 303d1821 | 0.5 | % ai/v | 9.00 a | ±3.0 | 5.60 a |
| 10 | 302d22 | 2 | % ai/v | 10.60 a | ±3.2 | 0.00 b |
| 11 | 302d22 | 1 | % ai/v | 9.80 a | ±2.5 | 1.00 b |
| 12 | 302d22 | 0.5 | % ai/v | 9.20 a | ±2.7 | 4.20 a |
| 13 | Parka | 5 | % v/v | 7.20 a | ±3.6 | 2.00 a |
| 14 | Danitol | 21 | fl oz/a | 3.80 a | ±1.8 | 0.00 a |
| | DW80 | 0.125 | % v/v | | | |
| 15 | Untreated | | | 6.20 a | ±2.3 | 5.40 a |
| | Check | | | | | |

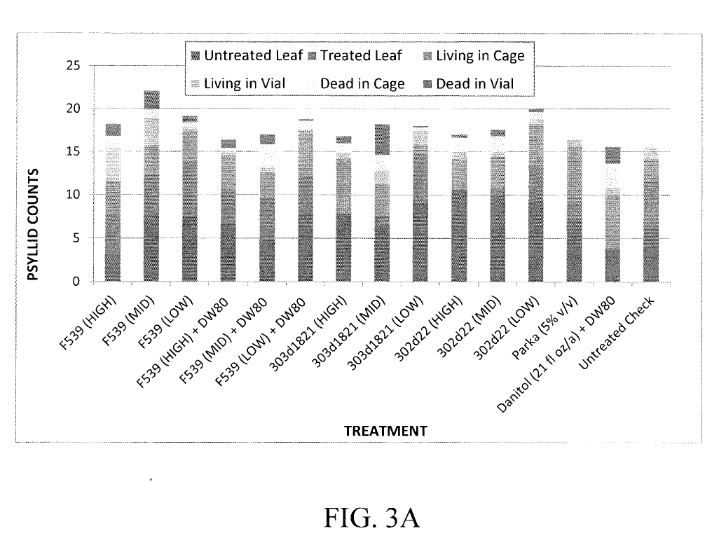

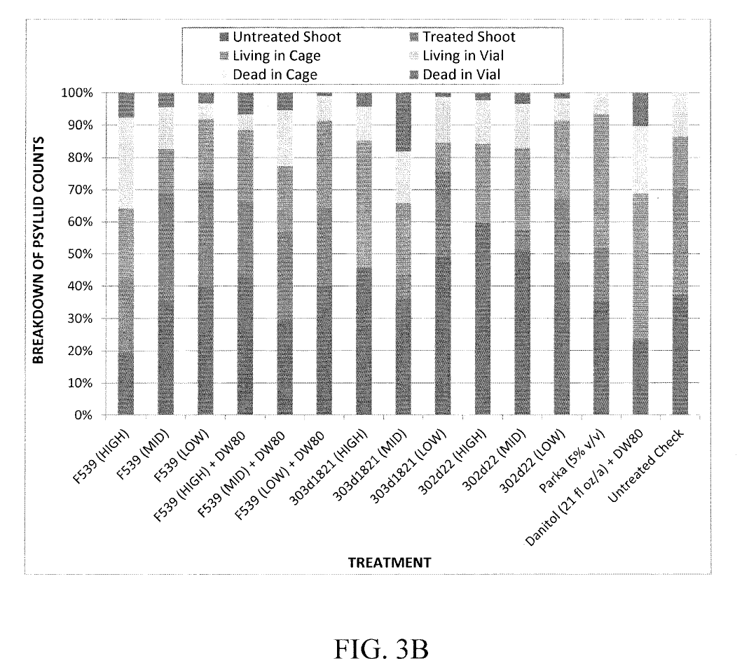

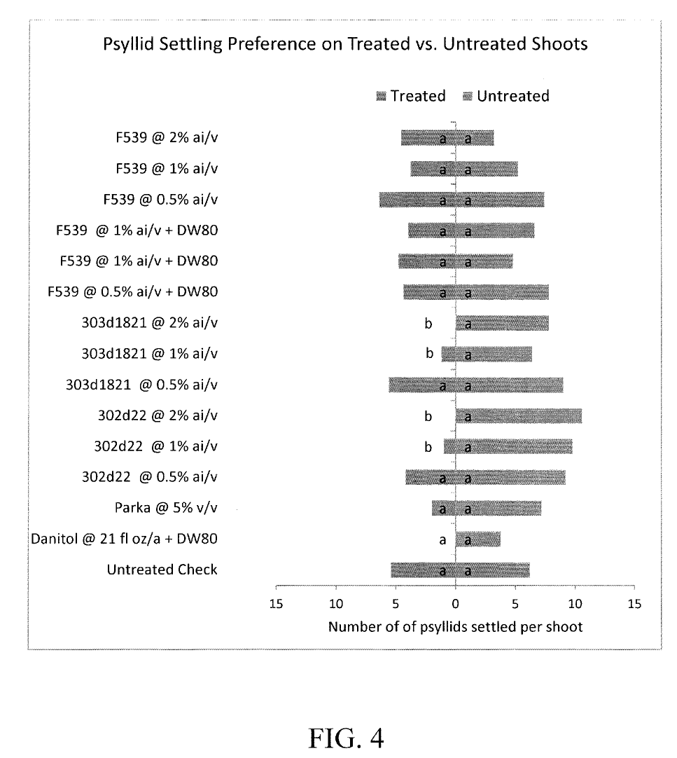

The results show that the number of ACP settled on the untreated shoot was significantly higher compared to that on treated in the two higher rates (1% and 2% ai/v) of both 303d1821 and 302d22 (FIGS. 2-4 and Tables 14-16).

### Example 3

### Young Citrus Tree Trial

OBJECTIVE: Test the phytoxic potential of the PARKA test-formulations with and without the active ingredient—Methyl Anthranilate (MA) repellent compound. Greenhouse testing at rates equivalent to expected field rates was conducted on young citrus trees (Valencia orange) in a greenhouse setting.

MATERIALS:
Spray bottles for applications: (500 ml utility spray bottle with adjustable nozzle)
36 young Valencia citrus trees: Potted Valencia Orange trees, entry size 12″-18.″
Flags or tape to mark treatments
PPE: Eye, skin, inhalation (mist)

OPERATIONAL: Two repellant formulations were tested. Both formulations contained equal concentrations of Parka (20% v/v). The formulations vary in their concentrations of repellent: an original formulation with concentration of 20% v/v (MA-20), vs. a high concentration AI formulation containing a 40% v/v concentration (MA-40). Application rates are based on the concentration of repellent used in the final spray mix. A 20% Parka formulation with glycerin substituted for MA is included as a means of differentiating any effects by the addition of anthranilate in the formulation. Treatments are applied with a standard utility spray bottle at approximately 30 sprays per tree, or “sprayed until wet.” (Spray to wet but not to drip). Treatments take place in the early morning to reduce the solar radiation variable. Trees are dry, and any visible debris removed prior to treatment. There will be 12 treatments total (see treatment list below).

TRIAL LAYOUT:

There are 24 trees total used in initial testing—2 reps for each of the 12 treatments, lined up side by side.

### Procedure:

### Trees Conditions:

1. Two trees are selected for each treatment. Trees are inspected and cleaned of any non-plant debris, and any unhealthy leaves that would be confused/assessed later as a phytotoxic reaction resulting from the treatments.

2. Trees are maintained for this test in the pots they arrived from the grower (plastic; approx. 5″ in diameter×12″ tall). Irrigated via drip irrigation.

3. Plants are placed on a 12′×5.5′,×32″ high mesh greenhouse tables. Philips LED supplemental photosynthetic lighting (400 nm-700 nm) is available (use TBD), suspended at 9 ft. above floor level.

Spray Technique using Zep Sprayer:

1. Tree coverage description: Droplet size calibration: adjusted for fine-wide spray pattern. Spray coverage includes front and back of all leaf surfaces until wet. On more vertical leaves, spray coverage is allowed to run-pool or accumulate along edges until dry.

2. A total of 200 mls of solution to be prepared for each treatment for coverage of two trees each. Spray Vol. measurement: Approx. 70 ml-80 ml (40) hand pumps required for complete coverage foliage on each tree.

3. Cleaning procedure between treatments: Spray equipment triple rinse with tap water between treatments.

TABLE 17
Treatment List

| | | | | | | Parka | |
|---|---|---|---|---|---|---|---|
| | | | Concentration | Concentration | MA* rates | Test rates | |
| Treatment | | Cultiva- | of MA* in | of Parka in | in spray | in spray | Application |
| Number | Formulation | Date/Lot | formula | formula | mix (v/v) | mix (v/v) | Frequency |
| 1 | Tap water | na | 0.0% | 0.0% | 0.0% | 0.0% | 1X |
| 2 | Cultiva: MA-1 | Jul. 27, 2018 | 20.0% | 20.0% | 0.5% | 0.5% | 1X |
| 3 | Cultiva: MA-1 | Jul. 27, 2018 | 20.0% | 20.0% | 1.0% | 1.0% | 1X |
| 4 | Cultiva: MA-1 | Jul. 27, 2018 | 20.0% | 20.0% | 2.0% | 2.0% | 1X |
| 5 | Cultiva: MA-40 | Jan. 18, 2019 | 40.0% | 20.0% | 0.5% | 0.25% | 1X |
| 6 | Cultiva: MA-40 | Jan. 18, 2019 | 40.0% | 20.0% | 1.0% | 0.5% | 1X |
| 7 | Cultiva: MA-40 | Jan. 18, 2019 | 40.0% | 20.0% | 2.0% | 1.0% | 1X |
| 8 | Cultiva: MA-40 | Jan. 18, 2019 | 40.0% | 20.0% | 4.0% | 2.0% | 1X |
| 9 | Cultiva: Parka 20% | Jan. 18, 2019 | 0.0% | 20.0% | 0.0% | 0.25% | 1X |
| 10 | Cultiva: Parka 20% | Jan. 18, 2019 | 0.0% | 20.0% | 0.0% | 0.5% | 1X |
| 11 | Cultiva: Parka 20% | Jan. 18, 2019 | 0.0% | 20.0% | 0.0% | 1.0% | 1X |
| 12 | Cultiva: Parka 20% | Jan. 18, 2019 | 0.0% | 20.0% | 0.0% | 2.0% | 1X |

*MA = Methyl Anthranilate

TABLE 18
Mix/spray information

| | | Tot. spray | | | AI/MA | Parka |
|---|---|---|---|---|---|---|
| | | vol. | | | dosage | dosage |
| Treatment | | prepared | mls formula | Formulation | per mix | per mix |
| Number | Formulation | (ml) | per 200 mls | Rate | (ml) | (ml) |
| 1 | Tap water | 200 | 0.00 | 0.0% | 0.00 | 0.00 |
| 2 | Cultiva: MA-1 | 200 | 5.00 | 2.5% | 1.00 | 1.00 |
| 3 | Cultiva: MA-1 | 200 | 10.00 | 5.0% | 2.00 | 2.00 |
| 4 | Cultiva: MA-1 | 200 | 20.00 | 10.0% | 4.00 | 4.00 |
| 5 | Cultiva: MA-40 | 200 | 2.50 | 1.25% | 1.00 | 0.50 |
| 6 | Cultiva: MA-40 | 200 | 5.00 | 2.5% | 2.00 | 1.00 |
| 7 | Cultiva: MA-40 | 200 | 10.00 | 5.0% | 4.00 | 2.00 |
| 8 | Cultiva: MA-40 | 200 | 20.00 | 10.0% | 8.00 | 4.00 |
| 9 | Cultiva: Parka 20% | 200 | 2.50 | 1.25% | 0.00 | 0.50 |
| 10 | Cultiva: Parka 20% | 200 | 5.00 | 2.5% | 0.00 | 1.00 |
| 11 | Cultiva: Parka 20% | 200 | 10.00 | 5.0% | 0.00 | 2.00 |
| 12 | Cultiva: Parka 20% | 200 | 20.00 | 10.0% | 0.00 | 4.00 |

### Data to be Collected:

Phytotoxicity (day 1, day 3-4, 1 week)
   Photos
   Visual score (0-100%)

### Results:

TABLE 19
Phytotoxicity Rating: Day 4 Post treatment

| | | | Parka | Highest | | | |
|---|---|---|---|---|---|---|---|
| Treatment | Formulation | MA conc. | conc. | leaf | Avg. leaf | % Foliage | |
| Rep | (mix rate % v/v) | % v/v) | (% v/v) | score | score | affected | Observations/notes: |
| 1A | H2O-check | 0.00% | 0.00% | 0 | 0 | 0 | |
| 1B | H2O-check | 0.00% | 0.00% | 0 | 0 | 0 | |
| 2A | MA-20 (2.5%) | 0.50% | 0.50% | 0 | 0 | 0 | |
| 2B | MA-20 (2.5%) | 0.50% | 0.50% | 0 | 0 | 0 | |
| 3A | MA-20 (5%) | 1.00% | 1.00% | 1 | <1 | 30 | Small yellow dots; 1-3 speckles per leaf |
| 3B | MA-20 (5%) | 1.00% | 1.00% | <1 | 0 | 10 | Very small speckles on a few leaves |
| 4A | MA-20 (10%) | 2.00% | 2.00% | 1 | 1 | 60 | Top ⅔rds of foliage have ~15% speckles, mostly on |
| | | | | | | | underside |
| 4B | MA-20 (10%) | 2.00% | 2.00% | 1 | 0-1 | 20 | More speckling on top half, few speckles on bottom |
| | | | | | | | half of plant |
| 5A | MA-40 (1.25%) | 0.50% | 0.25% | 0 | 0 | 0 | |
| 5B | MA-40 (1.25%) | 0.50% | 0.25% | 0 | 0 | 0 | Some veins are more neon, no speckles |
| 6A | MA-40 (2.5%) | 1.00% | 0.50% | 0 | 0 | 0 | Veins look more yellow than other plants |
| 6B | MA-40 (2.5%) | 1.00% | 0.50% | 0-1 | 0-1 | 5 | Tiny speckles on a few leaves |
| 7A | MA-40 (5%) | 2.00% | 1.00% | 2 | 1-2 | 50 | Upper ⅔rds plant has more phytotox than the |
| | | | | | | | lower portion |
| 7B | MA-40 (5%) | 2.00% | 1.00% | 2 | 1-2 | 50 | Upper ⅔rds have more phyto than bottom of plant |
| 8A | MA-40 (10%) | 4.00% | 2.00% | 4-5 | 4 | 85 | Defoliation; significant burn, plant lost ~¼^{th} of |
| | | | | | | | leaves |
| 8B | MA-40 (10%) | 4.00% | 2.00% | 3-4 | 3-4 | 90 | No defoliation, bottom leaves show mid to severe |
| | | | | | | | phytotox |
| 9A | Parka (1.25%) | 0.00% | 0.25% | 0 | 0 | 0 | |
| 9B | Parka (1.25%) | 0.00% | 0.25% | 0 | 0 | 0 | |
| 10A | Parka (2.5%) | 0.00% | 0.50% | 0 | 0 | 0 | |
| 10B | Parka (2.5%) | 0.00% | 0.50% | 0 | 0 | 0 | |
| 11A | Parka (5%) | 0.00% | 1.00% | 0 | 0 | 0 | |
| 11B | Parka (5%) | 0.00% | 1.00% | 0 | 0 | 0 | |
| 12A | Parka (10%) | 0.00% | 2.00% | 0 | 0 | 0 | |
| 12B | Parka (10%) | 0.00% | 2.00% | 0 | 0 | 0 | |

TABLE 20
Phytotoxicity Rating: Day 8 Post Treatment

| | | | Parka | Highest | | | |
|---|---|---|---|---|---|---|---|
| Treatment | Formulation | MA conc. | conc. | leaf | Avg. leaf | % Foliage | |
| Rep | (mix rate % v/v) | % v/v) | (% v/v) | score | score | affected | Observations/notes: |
| 1A | H2O-check | 0.00% | 0.00% | 0 | 0 | 0 | |
| 1B | H2O-check | 0.00% | 0.00% | 0 | 0 | 0 | |
| 2A | MA-20 (2.5%) | 0.50% | 0.50% | 0 | 0 | 0 | |
| 2B | MA-20 (2.5%) | 0.50% | 0.50% | 0 | 0 | 0 | |
| 3A | MA-20 (5%) | 1.00% | 1.00% | 0-1 | 0 | 0.1 | Minimal small phyto spots on ~5 leaves |
| 3B | MA-20: (5%) | 1.00% | 1.00% | 0-1 | 0 | 5-10 | A few dry speckles on a few leaves |
| 4A | MA-20 (10%) | 2.00% | 2.00% | 1 | 0-1 | 0.5 | Phyto appears on upper half of plant, tiny speckles |
| 4B | MA-20 (10%) | 2.00% | 2.00% | 1 | 0-1 | 0.6 | More phyto on top half of tree-small speckles |
| 5A | MA-40 (1.25%) | 0.50% | 0.25% | 0 | 0 | 0 | |
| 5B | MA-40 (1.25%) | 0.50% | 0.25% | 0 | 0 | 0 | |
| 6A | MA-40 (2.5%) | 1.00% | 0.50% | 0 | 0 | 0 | |
| 6B | MA-40 (2.5%) | 1.00% | 0.50% | 0 | 0 | 0 | |
| 7A | MA-40 (5%) | 2.00% | 1.00% | 2-3 | 1-2 | 0.5 | More phyto on top half; spots bleed together |
| 7B | MA-40 (5%) | 2.00% | 1.00% | 3 | 2 | 0.7 | More phyto on top half; several lg. speckles/leaf |
| 8A | MA-40 (10%) | 4.00% | 2.00% | 5 | 4 | 0.9 | Serious defoliation; significant phyto |
| 8B | MA-40 (10%) | 4.00% | 2.00% | 5 | 4 | 0.9 | Leave drop and shrivled leaves, burnt leaves on top |
| | | | | | | | half, wilted leaves on bottom half |
| 9A | Parka (1.25%) | 0.00% | 0.25% | 0 | 0 | 0 | |
| 9B | Parka (1.25%) | 0.00% | 0.25% | 0 | 0 | 0 | |
| 10A | Parka (2.5%) | 0.00% | 0.50% | 0 | 0 | 0 | |
| 10B | Parka (2.5%) | 0.00% | 0.50% | 0 | 0 | 0 | |
| 11A | Parka (5%) | 0.00% | 1.00% | 0 | 0 | 0 | |
| 11B | Parka (5%) | 0.00% | 1.00% | 0 | 0 | 0 | |
| 12A | Parka (10%) | 0.00% | 2.00% | 0 | 0 | 0 | |
| 12B | Parka (10%) | 0.00% | 2.00% | 0 | 0 | 0 | |

### Discussion:

Parka was tested in spray mixes using concentrations of 0.25% to 2.0% v/v with and without the presence of MA. Treatments 9A-12B, which have no AI, showed no evidence of phytotoxicity. Furthermore, the formulations containing 1% and less of repellent appeared to have insignificant phytotoxicity.

At, 2% v/v the MA-40 formulation shows slightly more phytotoxicity than the MA-20. Assuming all other factor being similar; the difference between these two treatments would be the difference in the level of Parka; MA-40 treated plants saw half the amount of Parka in relation to repellent.

Comparing equal rates of Parka, the high rate of 2% mixed with levels of 0, 2% an 4% repellent only showed significant phytotoxicity with the highest concentration of MA.

We claim:

1. A pest repellent composition comprising a repellent and a film-forming composition, wherein the film-forming composition comprises at least three components selected from film-forming matrices, hydrophobic barrier agents, complexing and crosslinking agents, plasticizers, film enhancing agents, UV protectants, and preservatives.

2. The pest repellent composition of claim 1, wherein the repellent is an anthranilate ester selected from methyl anthranilate; N,N-dimethyl anthranilic acid; ethyl anthranilate; and butyl anthranilate.

3. The pest repellent composition of claim 2, wherein the anthranilate ester is methyl anthranilate,

4. The pest repellent composition of claim 1, wherein the film forming matrix component is in an amount ranging from about 0.005% to about 10% by weight.

5. The pest repellent composition of claim 1, wherein the hydrophobic barrier component is in an amount ranging from about 0.001% to about 25% by weight.

6. The pest repellent composition of claim 1, wherein the complexing and crosslinking component is in an amount ranging from about 0.005% to about 10% by weight.

7. The pest repellent composition of claim 1, wherein the plasticizer component is in an amount ranging from about 0.01% to about 35% by weight.

8. The pest repellent composition of claim 1, wherein the film enhancing component is in an amount ranging from about 0.005% to about 15% by weight.

9. The pest repellent composition of claim 1, wherein, upon application of the composition to a plant, or plant part, the composition forms an exogenous flexible film thereon.

10. The pest repellent composition of claim 1, wherein the repellent is at a concentration of about 0.5% to 2.5%.

11. The pest repellent composition of claim 3, wherein the methyl anthranilate is at a concentration of about 1% to about 2% and the film-forming composition is at a concentration of about 0.5% to about 5%.

12. The pest repellent composition of claim 1, wherein the composition is an emulsion.

13. The pest repellent composition of claim 1, wherein the composition comprises components in the proportions provided in any one of Formulae C, D, H, L, or M-S.

14. A method of repelling a pest comprising applying to a surface, an effective amount of the pest repellent composition of claim 1.

15. The method of claim 14, wherein the surface is a plant or plant part.

16. The method of claim 15, wherein the plant is a citrus plant.

17. The method of claim 14, wherein the pest is a psyllid.

18. The method of claim 17, wherein the psyllid is an ACP.

19. The method of claim 15, wherein the plant part is selected from fruits, vegetables and flowers.

20. A method for protecting an agricultural crop against a pest comprising treating the agricultural crop to be protected from said pest with an effective amount of the pest repellent composition of claim 1 by applying the pest repellent composition to the agricultural crop.

21. The method of claim 20, wherein the agricultural crop is a citrus plant.

22. The method of claim 20, wherein the pest is a psyllid.

23. The method of claim 22, wherein the psyllid is an ACP.

24. The method of claim 20, wherein the treatment is applied prior to harvesting.
